(19) United States
(12) Patent Application Publication
(10) Pub. No.: US 2021/0367795 A1
(43) Pub. Date: Nov. 25, 2021

(54) Identity-Linked Authentication Through A User Certificate System

(71) Applicant: Averon US, Inc., Henderson, NV (US)

(72) Inventors: Wendell Brown, Henderson, NV (US); Mark Klein, Henderson, NV (US)

(21) Appl. No.: 17/202,187

(22) Filed: Mar. 15, 2021

Related U.S. Application Data
(63) Continuation of application No. 16/183,975, filed on Nov. 8, 2018, now abandoned.
(60) Provisional application No. 62/583,352, filed on Nov. 8, 2017.

(51) Int. Cl. H04L 9/32; H04L 9/08; H04L 29/06

(52) U.S. Cl. CPC H04L 9/3263; H04L 9/321; H04L 9/3228; H04L 9/0894; H04L 63/0428; G06F 21/33; H04L 63/102; H04L 63/0853; H04L 63/0884; H04L 63/0815; H04L 63/0823; H04L 63/18

(57) ABSTRACT

Systems, methods, apparatuses, and computer readable media for facilitating user identity authentication to a service provider by linking, on a user certificate system, identity-linked information to certificate information, such that the certificate information may be used to generate an identity message that the service provider may verify to confirm a user identity. An exemplary method comprises receiving identity-linked information, retrieving public certificate information, retrieving, from a hardware security module, a private key, causing transmission, over a second network to the service provider, of a notification that an identity message is available for access, the identity message based on the retrieved public certificate information and the retrieved private key, and upon reception, from the service provider, of a request for the identity message, generating and transmitting the identity message, wherein the identity message comprises at least an encrypted portion of the identity message encrypted using at least the private key.

### CROSS-REFERENCE TO RELATED APPLICATIONS

This application claims priority to U.S. Provisional Application No. 62/583,352 filed Nov. 8, 2017, the content of which is incorporated herein by reference in its entirety.

### TECHNOLOGICAL FIELD

Embodiments of the invention relate, generally, to facilitating user identity authentication to a service provider by using Public-Key Interface (“PKI”) certificates linked to information on a user certificate system to convey identity, and more specifically, to linking identity-linked information associated with user device possession attestation, such as a phone number or other device-linked identification number, to certificate information accessible on a user certificate system for use in generating an identity message that may be verified by the service provider to confirm a. user identity.

### BACKGROUND

Each HTIPS-enabled service provider has certificates installed on their web servers that identify the service provider to a user and allows the user's web browser to securely communicate with the service provider. However, typically, the service provider does not have reciprocal assurance of the user's identity. To facilitate identification of the user, service providers often perform authentication using a username and password, and in some systems, perform a second factor of authentication, such as a one-time password (“OTP”) over short message service (“SMS”). While conventional transport layer security (“TLS”) protocols have client certificate functionality built in and supported by all major web browsers, the technical expertise required to acquire, install, and manage a client certificate on a web browser, along with the access control required to prevent unauthorized use, has severely limited the adoption of this form of user identification.

The applicant has discovered problems with current systems, methods, and apparatuses and through applied effort, ingenuity, and innovation, Applicant has solved many of these identified problems by developing a solution that is embodied by the present invention, which is described in detail below.

### BRIEF SUMMARY

In general, embodiments of the present invention provided herein include systems, methods, apparatuses, and computer readable media for facilitating user authentication to a service provider by linking, on a user certificate system, identity-linked information to certificate information, such that the certificate information may be used to generate an identity message that the service provider may verify to confirm a user identity.

Other systems, methods, and features will be, or will become, apparent to one with skill in the art upon examination of the following figures and detailed description. It is intended that all such additional systems, methods, features to be included within this description, be within the scope of the disclosure, and be protected by the following claims.

In some embodiments, an apparatus may be provided comprising at least one processor and at least one memory including computer program code, the at least one memory and the computer program code configured to, with the processor, cause the apparatus to at least: receive, over a first network, identification information comprising at least identity-linked information; query for information linked to the identity-linked information; receive result data indicative of a determination that the user certificate system does not contain information linked to the identity-linked information; cause certificate information to be linked to the identity-linked information, wherein the certificate information comprises at least public certificate information and a private key, and wherein the public certificate information comprises at least a public key; store the public certificate information in the user certificate repository; store the private key in a hardware security module; cause transmission, to the service provider over a second network, of a linking completed notification indicative of at least a portion of the public certificate information being accessible using a session ID; receive, from the service provider, a request for the public certificate information, the request for the public certificate information comprising at least the session ID; and transmit, to the service provider, at least the portion of the public certificate information linked to the identity-linked information, wherein the portion of the certificate information comprises at least the public key.

In some embodiments, the first network is an out-of-band network with respect to the second network.

In some embodiments, the first network is a carrier network.

In some embodiments, the identification information is received over the first network from a carrier using header enrichment.

In some embodiments, the identification information further comprises the session ID,

In some embodiments, the computer program code is further configured to: generate the session ID in response to receiving the identification information; and wherein cause transmission of the notification to the service provider comprising at least transmitting response information to a user device, the response information comprising at least the generated session ID.

In some embodiments, the computer program code is further configured to: generate a key pair, the key pair comprising the public key and the private key; cause a certificate authority to generate certificate validation information associated with the key pair and the identity-linked information; and associate the certificate validation information with the public certificate information.

In some embodiments, the computer program code is further configured to: cause a certificate authority to generate the private key and the public key; and receive, from the certificate authority, the certificate information associated with the identity-linked information.

In some embodiments, the certificate information further comprises certificate validation information such that the certificate validation information can be used to verify the certificate information up to a trusted certificate authority,

In some embodiments, the public certificate information is stored in X.509 certificate format.

In some embodiments, the identification information additionally comprises information indicative of a device possession confirmation event.

In some embodiments, the identification information is received in response to accessing a link sent via SMS to a first user device, the first user device receiving the link via SMS in response to a request for services sent to the service provider by a second user device associated with the first user device.

In some embodiments, the identification information is received in response to a local device message on a first user device, the first user device receiving the local device message in response to a request for services sent to a service provider by a second user device associated with the first user device.

In some embodiments, the computer program code is further configured to: receive the identification information occurs in response to a redirect on a user device.

In some embodiments, the computer program code is further configured to: cause the certificate information to be linked to the identity-linked information comprises linking the user with an ID-VERIFIED certificate authenticated through a certificate authority verification process.

In some embodiments, the computer program code is further configured to: cause the certificate information to be linked to the identity-linked information comprising the steps of at least linking the certificate information with service provider identification information.

In some embodiments, the computer program code is further configured to: cause certificate information to be linked to the identity-linked information comprising the steps of generating the certificate information associated with the identity-linked information.

In some embodiments, the method of claim 1, wherein the identity-linked information is one from the set of (1) a one-time password, (2) a one-time password over SMS, (3) a passcode from the user device running a time-based one-time-password algorithm, (4) a passcode from a different user device running a time-based one-time-password algorithm, (5) a passcode from the user device running a HMAC-based one-time-password algorithm, (6) a passcode from a different user device running a HMAC-based one-time-password algorithm, (7) a FIDO key from the user device, (8) a FIDO key from a different user device, (9) an identifier associated with a device-connected service provider device and service provider attestation information, (10) a biometric indicator, or (11) a phone number associated with the user device.

In some embodiments, the public certificate information comprises at least one from the group of (1) a name, (2) a social security number, (3) an identification number, and (4) a unique attribute of the user.

In some embodiments, the computer program code is further configured to: cause the certificate information to be linked to the identity-linked information comprising the steps of at least linking the certificate information with a credit card number.

In some embodiments, a portion of the identity-linked information comprises at least one from the group of (1) a phone number in plain-text, (2) a phone number in hashed form, and (3) a credit card number.

In some embodiments, the identification information comprises an additional identification information portion, and wherein the method further comprises storing the additional identification information portion as part of the public certificate information.

In some embodiments, the computer program code is further configured to: cause a device possession confirmation event on a user device.

In some embodiments, the identification information further comprises a secret key.

In some embodiments, the computer program code is further configured to: encrypt at least the private key in the hardware security module using the secret key.

In some embodiments, the computer program code is further configured to: generate a transaction report comprising at least information that uniquely memorializes the transmission of at least the portion of the certificate information. linked to the identity-linked information; and store the transaction record in a ledger.

In some embodiments, the computer program code is further configured to: store the transaction record in a ledger comprises storing the transaction record on a blockchain.

In some embodiments, an apparatus may be provided comprising at least one processor and at least one memory including computer program code, the at least one memory and the computer program code configured to, with the processor, cause the apparatus to at least: receive, over a first network, identification information comprising at least identity-linked information; retrieve, from a user certificate repository, public certificate information associated with the identity-linked information; retrieve, from a hardware security module, a private key associated with the identity-linked information; cause transmission, over a second network to the service provider, of an information preparation notification indicative that an identity message is ready to be accessed based on a session ID, wherein the identity message is based on the retrieved public certificate information and the retrieved private key; receive, from the service provider, a request for the identity message, the request for identification comprising at least the session ID; generate the identity message, wherein the identity message comprises at least an encrypted portion of the identity message encrypted using at least the private key; and transmit the identity message to the service provider.

In some embodiments, the computer program code is further configured to: cause the service provider to decrypt the encrypted portion of the identity message using a public key paired with the private key.

In some embodiments, a portion of the identity message comprises at least one from the set of (1) an empty message, (2) a phone number, (3) a transaction time-stamp, and (4) additional identification information.

In some embodiments, the identification information additionally comprises a history key, and the computer program code is further configured to: receive the history key; validate the history key by decrypting it; and retrieve the public certificate information from the user certificate repository using the history key.

In some embodiments, the computer program code is further configured to: retrieve the public certificate information further comprises determining the public certificate information is associated with service provider identification information.

In some embodiments, the computer program code is further configured to: determine a set of identity verification documents associated with the identity-linked information, wherein the set of identity verification documents is stored in a user identification document repository; select a document in the set of identity verification documents; and perform a document action on the selected document.

In some embodiments, the public certificate information comprises at least one from the group of (1) a name, (2) a social security number, (3) an identification number, and (4) a unique attribute of the user.

In some embodiments, the computer program code is further configured to: generate a transaction report, wherein the transaction report comprises information that uniquely memorializes the transmission of the identity message to the service provider; and store the transaction report in a ledger.

In some embodiments, the computer program code is further configured to: decrypt the private key using the additional secret key.

In some embodiments, the public certificate information at least a public key, and wherein the identity message comprises the encrypted portion and an unencrypted portion, and wherein the unencrypted portion of the identity message comprises at least the public certificate information.

In some embodiments, the public certificate information further comprises certificate validation information such that the certificate validation information can be used to verify the public certificate information was issued from a trusted certificate authority.

In some embodiments, a method of registering an authorized user to a user certificate system may be provided, the method comprising receiving, over a first network, identification information comprising at least identity-linked information, querying for information linked to the identity-linked information, receiving result data indicative of a determination that the user certificate system does not contain information linked to the identity-linked information, causing certificate information to be linked to the identity-linked information, wherein the certificate information comprises at least public certificate information and a private key, and wherein the public certificate information comprises at least a public key, storing the public certificate information in the user certificate repository, storing the private key in a hardware security module, causing transmission, to the service provider over a second network, of a linking completed notification indicative of at least a portion of the public certificate information being accessible using a session ID, receiving, from the service provider, a request for the public certificate information, the request for the public certificate information comprising at least the session ID, and transmitting, to the service provider, at least the portion of the public certificate information linked to the identity-linked information, wherein the portion of the certificate information comprises at least the public key.

In some embodiments, the first network is an out-of-band network with respect to the second network. In some embodiments, the first network is a carrier network. In some embodiments, the identification information is received over the first network using header enrichment. In some embodiments, the identification information further comprises the session ID.

In some embodiments, the method may further comprise generating the session ID in response to receiving the identification information, wherein causing transmission of the notification to the service provider comprises at least transmitting response information to a user device, the response information comprising at least the generated session ID.

In some embodiments, causing the certificate information to be linked to the identity-linked information comprises generating a key pair, the key pair comprising the public key and the private key, causing a certificate authority to generate certificate validation information associated with the key pair and the identity-linked information, and associating the certificate validation information with the public certificate information. In some embodiments, causing the certificate information to be linked to the identity-linked information comprise causing a certificate authority to generate the private key and the public key, and receiving, from the certificate authority, the certificate information associated with the identity-linked information.

In some embodiments, the certificate information further comprises certificate validation information such that the certificate validation information can be used to verify the certificate information up to a trusted certificate authority. In some embodiments, the public certificate information is stored in X.509 certificate format. In some embodiments, identification information additionally comprises information indicative of a device possession confirmation event.

In some embodiments, the identification information is received in. response to accessing a link sent via SMS to a first user device, and the first user device receiving the link via SMS it response to a request for services sent to the service provider by a second user device associated with the first user device. In some embodiments, the identification information is received in response to a local device message on a first user device, the first user device receiving the local device message in response to a request for services sent to a service provider by a second user device associated with the first user device.

In some embodiments, receiving the identification information occurs in response to a redirect on a user device, In some embodiments, causing the certificate information to be linked to the identity-linked information comprises linking the user with an ID-VERIFIED certificate authenticated through a certificate authority verification process.

In some embodiments, causing the certificate information to be linked to the identity-linked information comprises at least linking the certificate information with service provider identification information. In some embodiments, causing certificate information to be linked to the identity-linked information comprises generating the certificate information associated with the identity-linked information.

In some embodiments, the identity-linked information is one from the set of (1) a one-time password, (2) a one-time password over SMS, (3) a passcode from a first user device running a time-based one-time-password algorithm, (4) a passcode from a second user device running a time-based one-time-password algorithm, (5) a passcode from a first user device running a HMAC-based one-time-password algorithm, (6) a passcode from a second user device running a HMAC-based one-time-password algorithm, (7) a FIDO key from a first user device, (8) a FIDO key from a second user device, (9) an identifier associated with a device-connected service provider device and service provider attestation information, (10) a biometric indicator, or (11) a phone number associated with a user device.

In some embodiments, the public certificate information comprises at least one from the group of (1) a name, (2) a social security number, (3) an identification number, and (4) a unique attribute of the user.

In some embodiments, causing the certificate information to be linked to the identity-linked information comprises at least linking the certificate information with a credit card number.

In some embodiments, a portion of the identity-linked information comprises at least one from the group of (1) a phone number in plain-text, (2) a phone number in hashed form, and (3) a credit card number. In some embodiments, the identification information comprises an additional. identification information portion, and wherein the method further comprises storing the additional identification information portion as part of the public certificate information.

In some embodiments, the method may further comprise causing a device possession confirmation event on a user device. In some embodiments, the identification information further comprises a secret key. In some embodiments, the method may further comprise encrypting at least the private key in the hardware security module using the secret key.

In some embodiments, the method may further comprise generating a transaction report comprising at least information that uniquely memorializes the transmission of at least the portion of the certificate information linked to the identity-linked information, and storing the transaction record in a ledger. In some embodiments, storing the transaction record in a ledger comprises storing the transaction record on a blockchain.

In some embodiments, a method of providing user identity authentication information to a service provider may be provided, the method comprising receiving, over a first network, identification information comprising at least identity-linked information, retrieving, from a user certificate repository, public certificate information associated with the identity-linked information, retrieving, from a hardware security module, a private key associated with the identity-linked information, causing transmission, over a second network to the service provider, of an information preparation notification indicative that an identity message is ready to be accessed based on a session ID, wherein the identity message is based on the retrieved public certificate information and the retrieved private key, receiving, from the service provider, a request for the identity message, the request for identification comprising at least the session ID, generating the identity message, wherein the identity message comprises at least an encrypted portion of the identity message encrypted using at least the private key, and transmitting the identity message to the service provider.

In some embodiments, the first network is an out-of-band from the communications network, In some embodiments, the first network is a carrier network. In some embodiments, the identification information is received over the first network using header enrichment. In some embodiments, the identification information further comprises the session ID.

In some embodiments, the method further comprises generating the session ID in response to receiving the identification information, wherein causing transmission of the notification to the service provider comprises at least transmitting response information to a user device, the response information comprising at least the generated session ID.

In some embodiments, transmitting the identity message causes the service provider to decrypt the encrypted portion of the identity message using a public key paired with the private key. In some embodiments, a portion of the identity message comprises at least one from the set of (1) an empty message, (2) a phone number, (3) a transaction time-stamp, and (4) additional identification information. In some embodiments, the identification information additionally comprises information indicative of a device possession confirmation event.

In some embodiments, the identification information additionally comprises a history key, and the method may further comprise receiving the history key, validating the history key by decrypting it, and using the history key to retrieve the public certificate information from the user certificate repository.

In some embodiments, the identification information is received in response to accessing a link sent via SMS to a first user device, the first user device receiving the link via SMS in response to a request for services sent to the service provider by a second user device associated with the first user device. In some embodiments, the identification information is received in response to a local device message on a first user device, the first user device receiving the local device message in response to a request for services sent to a service provider by a second user device associated with the first user device. In some embodiments, receiving the identification information occurs in response to a redirect on a user device.

In some embodiments, retrieving the public certificate information further comprises determining the public certificate information is associated with service provider identification information.

In some embodiments, the method may further comprise, after transmitting the identity message determining a set of identity verification documents associated with the identity-linked information, wherein the set of identity verification documents is stored in a user identification document repository, selecting a document in the set of identity verification documents, and performing a document action on the selected document.

In some embodiments, the identity-linked information is one from the set of (1) a one-time password, (2) a one-time password over SMS, (3) a passcode from a first user device running a time-based one-time-password algorithm, (4) a passcode from a second user device running a time-based one-time-password algorithm, (5) a passcode from a first user device running a HMAC-based one-time-password algorithm, (6) a passcode from a second user device running a HMAC-based one-time-password algorithm, (7) a FIDO key from a first user device, (8) a FIDO key from a second user device, (9) an identifier associated with a device-connected service provider device and service provider attestation information, (10) a biometric indicator, or (11) a phone number associated with a user device.

In some embodiments, the public certificate information comprises at least one from the group of (1) a name, (2) a social security number, an identification number, and (4) a unique attribute of the user.

In some embodiments, the method may further comprise causing a device possession confirmation event on a user device. In some embodiments, a portion of the identity-linked information comprises at least one from the group of (1) a phone number in plain-text, (2) a phone number in hashed form, and (3) a credit card number.

In some embodiments, the method may further comprise generating a transaction report, wherein the transaction report comprises information that uniquely memorializes the transmission of the identity message to the service provider, and storing the transaction report. In a ledger. In some embodiments, the ledger comprises a blockchain.

In some embodiments, the identification information further comprises a secret key. In sortie embodiments, the method further comprises before encrypting the portion of identity message, decrypting the private key using the additional secret key.

In some embodiments, the public certificate information comprises at least a public key, the identity message comprises the encrypted portion and an unencrypted portion, and the unencrypted portion of the identity message comprises at least the public certificate information,

In some embodiments, the public certificate information further comprises certificate validation information such that the certificate validation information can be used to verify the public certificate information was issued from a trusted certificate authority.

In some embodiments, an apparatus configured to register an authorized user to a user certificate system may be provided, the apparatus comprising at least a processor and a memory associated with the processor having computer coded instructions therein, with the computer coded instructions configured to, when executed by the processor, cause the apparatus to receive, over a first network, identification information comprising at least identity-linked information, query for information linked to the identity-linked information, receive result data indicative of a determination that the user certificate system does not contain information linked to the identity-linked information, cause certificate information to be linked to the identity-linked information, wherein the certificate information comprises at least public certificate information and a private key, and wherein the public certificate information comprises at least a public key, store the public certificate information in the user certificate repository, store the private key in a hardware security module, cause transmission, to the service provider over a second network, of a linking completed notification indicative of at least a portion of the public certificate information being accessible using a session ID, receive, from the service provider, a request for the public certificate information, the request for the public certificate information comprising at least the session ID, and transmit, to the service provider, at least the portion of the public certificate information linked to the identity-linked information, wherein the portion of the certificate information comprises at least the public key.

In some embodiments, an apparatus configured to provide user identity authentication information to a service provider may be provided, the apparatus comprising at least a processor and a memory associated with the processor having computer coded instructions therein, with the computer coded instructions configured to, when executed by the processor, cause the apparatus to receive, over a first network, identification information comprising at least identity-linked information, retrieve, from a user certificate repository, public certificate information. associated with the identity-linked information, retrieve, from a hardware security module, a private key associated with the identity-linked information, cause transmission, over a second network to the service provider, of an information preparation notification indicative that an identity message is ready to be accessed based on a session ID, wherein the identity message is based on the retrieved public certificate information and the retrieved private key, receive, from the service provider, a request for the identity message, the request for identification comprising at least the session ID, generate the identity message, wherein the identity message comprises at least an encrypted portion of the identity message encrypted using at least the private key, and transmit the identity message to the service provider.

In some embodiments, a computer program product for registering an authorized user to a user certificate system may be provided, the computer program product comprising at least one non-transitory computer-readable storage medium having computer-executable program code instructions stored therein, the computer-executable program code instructions comprising program code instructions for receiving, over a first network, identification information comprising at least identity-linked information, querying for information linked to the identity-linked information, receiving result data indicative of a determination that the user certificate system does not contain information linked to the identity-linked information, causing certificate information to be linked to the identity-linked information, wherein the certificate information comprises at least public certificate information and a private key, and wherein the public certificate information comprises at least a public key, storing the public certificate information in the user certificate repository, storing the private key in a hardware security module, causing transmission, to the service provider over a second network, of a linking completed notification indicative of at least a portion of the public certificate information being accessible using a session ID, receiving, from the service provider, a request for the public certificate information, the request for the public certificate information comprising at least the session ID, and transmitting, to the service provider, at least the portion of the public certificate information linked to the identity-linked information, wherein the portion of the certificate information comprises at least the public key.

In some embodiments, a computer program product for providing user identity authentication information to a service provider may be provided, the computer program product comprising at least one non-transitory computer-readable storage medium having computer-executable program code instructions stored therein, the computer-executable program code instructions comprising program code instructions for receiving, over a first network, identification information comprising at least identity-linked information, retrieving, from a user certificate repository, public certificate information associated with the identity-linked information, retrieving, from a hardware security module, a private key associated with the identity-linked information, causing transmission, over a second network to the service provider, of an information preparation notification indicative that an identity message is ready to be accessed based on a session ID, wherein the identity message is based on the retrieved public certificate information and the retrieved private key, receiving, from the service provider, a request for the identity message, the request for identification comprising at least the session ID, generating the identity message, wherein the identity message comprises at least an encrypted portion of the identity message encrypted using at least the private key, and transmitting the identity message to the service provider.

In some embodiments, a method of authenticating a user identity using information linked to identity-linked information on a user certificate system may be provided, the method comprising transmitting, to the service provider over a first network, a request for services, receiving, from the service provider, a link to the user certificate system, accessing the link, transmitting, to the user certificate system over a second network, identification information comprising at least identity-linked information, and causing the user certificate system to link certificate information to the identity-linked information, the certificate information comprising at least a public key and a private key, and receiving, from the user certificate system, a notification indicative that the information linked to the user is ready to be accessed based on a session ID, transmitting, to the service provider, a notification indicative the information linked to the user is ready to be accessed based on the session ID, and causing the service provider to retrieve, from the user certificate system, public certificate information linked to the user, wherein the public certificate information comprises at least the public key.

In some embodiments, a method of authenticating a user identity using a user certificate system may be provided, the method comprising transmitting, to the service provider over a first network, a request for services, receiving, from the service provider, a link to the user certificate system, accessing the link, transmitting, to the user certificate system over a second network, identification information comprising at least identity-linked information, and causing the user certificate system to prepare to access certificate information linked to the identity-linked information, wherein the certificate information may be used to generate an identity message, the certificate information comprising at least a private key, and receiving, from the user certificate system, a response indicative of the identity message being accessible based on a session ID, transmitting, to the service provider, an identity preparation notification indicative of the identity message being accessible based on a session ID, and causing the service provider to retrieve, from the user certificate system, the identity message using at least the session ID, wherein the identity message can be validated by decrypting an encrypted portion of the identity message.

In some embodiments, an apparatus configured to authenticate a user identity using information linked to identity-linked information on a user certificate system, may be provided, the apparatus comprising at least a processor and a memory associated with the processor having computer coded instructions therein, with the computer coded instructions configured to, when executed by the processor, cause the apparatus to transmit, to the service provider over a first network, a request for services, receive, from the service provider, a link to the user certificate system, access the link, transmit, to the user certificate system over a second network, identification information comprising at least identity-linked information, and cause the user certificate system to link certificate information to the identity-linked information, the certificate information comprising at least a public key and a private key, and receive, from the user certificate system, a notification indicative the information linked to the user is ready to be accessed based on a session ID, transmit, to the service provider, a notification indicative the information linked to the user is ready to be accessed based on the session ID, and cause the service provider to retrieve, from the user certificate system, public certificate information linked to the user, wherein the public certificate information comprises at least the public key.

In some embodiments, an apparatus configured to authenticate a user identity using a user certificate system may be provided, the apparatus comprising at least a processor and a memory associated with the processor having computer coded instructions therein, with the computer coded instructions configured to, when executed by the processor, cause the apparatus to transmit, to the service provider over a first network, a request for services, receive, from the service provider, a link to the user certificate system, access the link, transmit, to the user certificate system over a second network, identification information comprising at least identity-linked information, and cause the user certificate system to prepare to access certificate information linked to the identity-linked information, wherein the certificate information may be used to generate an identity message, the certificate information comprising at least a private key, and receive, from the user certificate system, a response indicative of the identity message being accessible based on a session ID, transmit, to the service provider, an identity preparation notification indicative of the identity message being accessible based on a session ID, and cause the service provider to retrieve, from the user certificate system, the identity message using at least the session ID, wherein the identity message can be validated by decrypting an encrypted portion of the identity message.

In some embodiments, computer program product for authenticating a user identity using information linked to identity-linked information on a user certificate system may be provided, the computer program product comprising at least one non-transitory computer-readable storage medium having computer-executable program code instructions stored therein, the computer-executable program code instructions comprising program code instructions for transmitting, to the service provider over a first network, a request for services, receiving, from the service provider, a link to the user certificate system, accessing the link, transmitting, to the user certificate system over a second network, identification information comprising at least identity-linked information, and causing the user certificate system to link certificate information to the identity-linked information, the certificate information comprising at least a public key and a private key, and receiving, from the user certificate system, a notification indicative that the information linked to the user is ready to be accessed based on a session ID, transmitting, to the service provider, a notification indicative the information linked to the user is ready to be accessed based on the session ID, and causing the service provider to retrieve, from the user certificate system, public certificate information linked to the user, wherein the public certificate information comprises at least the public key.

In some embodiments, a computer program product for authenticating a user identity using a user certificate system may be provided, the computer program product comprising at least one non-transitory computer-readable storage medium haying computer-executable program code instructions stored therein, the computer-executable program code instructions comprising program code instructions for transmitting, to the service provider over a first network, a request for services, receiving, from the service provider, a link to the user certificate system, accessing the link, transmitting, to the user certificate system over a second network, identification information comprising at least identity-linked information, and causing the user certificate system to prepare to access certificate information linked to the identity-linked information, wherein the certificate information may be used to generate an identity message, the certificate information comprising at least a private key, and receiving, from the user certificate system, a response indicative of the identity message being accessible based on a session ID, transmitting, to the service provider, an identity preparation notification indicative of the identity message being accessible based on a session ID, and causing the service provider to retrieve, from the user certificate system, the identity message using at least the session ID, wherein the identity message can be validated by decrypting an encrypted portion of the identity message.

In some embodiments, a method of registering information for a user using a user certificate system may be provided, the method comprising receiving, from a user device over a first network, a request for services associated with a user profile, configuring a registration link such that accessing the registration link causes transmission, from the user device to the user certificate system over a second network, of identification information, wherein the identification information. comprises at least identity-linked information, providing the registration. link to the user device, receiving, from the user device, a notification indicating certificate information linked to the user is ready to be accessed, on the user certificate system, based on a session ID, transmitting, to the user certificate system, a request for the certificate information, wherein the request for the certificate information comprises at least the session ID, receiving, from the user certificate system, the certificate information comprising at least a public key, and storing the certificate information, wherein the certificate information stored comprises at least the public key, and wherein the information associated with the certificate is stored associated with the user profile.

In some embodiments, a method of authenticating a user identity using a user certificate system may be provided, the method comprising receiving, from a user device over a first network, a request for services from a user profile, configuring an identity confirmation link such that accessing the identity confirmation link causes transmission, from the user device to the user certificate system over a device network, of identification information, wherein the identification. information comprises at least identity-linked information, providing the identity confirmation link to the user device, receiving, from the user device, an information preparation notification, wherein the information preparation notification is indicative of an identity message being accessible, on the user certificate system, using a session ID, wherein the identity message is based on certificate information linked to the identity-linked information, transmitting, to the user certificate system, an identification request, wherein the identification request comprises at least the session ID, receiving, from the user certificate system, the identity message comprising an encoded portion, and validating the identity message by decrypting, using a public key associated with the identity linked identifier, the encoded portion of the identity message.

In some embodiments, an apparatus configured to register information for a user using a user certificate system may be provided, the apparatus comprising at least a processor and a memory associated with the processor having computer coded instructions therein, with the computer coded instructions configured to, when executed by the processor, cause the apparatus to receive, from a user device over a first network, a request for services associated with a user profile, configure a registration. link such that accessing the registration. link causes transmission, from the user device to the user certificate system over a second network, of identification information, wherein the identification information comprises at least identity-linked information, provide the registration link. to the user device, receive, from the user device, a notification indicating certificate information linked to the user is ready to be accessed, on the user certificate system, based on a session ID, transmit, to the user certificate system, a request for the certificate information, wherein the request for the certificate information comprises at least the session ID, receive, from the user certificate system, the certificate information comprising at least a public key, and store the certificate information, wherein the certificate information stored comprises at least the public key, and wherein the information associated with the certificate is stored associated with the user profile.

In some embodiments, an apparatus configured to authenticate a user identity using a user certificate system may be provided, the apparatus comprising at least a processor and a memory associated with the processor having computer coded instructions therein, with the computer coded instructions configured to, when executed by the processor, cause the apparatus to receive, from a user device over a first network, a request for services from a user profile, configure an identity confirmation link such that accessing the identity confirmation link causes transmission, from the user device to the user certificate system over a device network, of identification information, wherein the identification information comprises at least identity-linked information, provide the identity confirmation link. to the user device, receive, from the user device, an information preparation notification, wherein the information preparation notification is indicative of an identity message being accessible, on the user certificate system, using a session ID, wherein the identity message is based on certificate information linked to the identity-linked information, transmit, to the user certificate system, an identification request, wherein the identification request comprises at least the session ID, receive, from the user certificate system, the identity message comprising an encoded portion, and validate the identity message by decrypting, using a public key associated with the identity linked identifier, the encoded portion of the identity message.

In some embodiments, a computer program product for registering information for a user using a user certificate system may be provided, the computer program product comprising at least one non-transitory computer-readable storage medium having computer-executable program code instructions stored therein, the computer-executable program code instructions comprising program code instructions for receiving, from a user device over a first network, a request for services associated with a user profile, configuring a registration link such that accessing the registration link causes transmission, from the user device to the user certificate system over a second network, of identification information, wherein the identification information comprises at least identity-linked information, providing the registration link. to the user device, receiving, from the user device, a notification indicating certificate information linked to the user is ready to be accessed, on the user certificate system, based on a session ID, transmitting, to the user certificate system, a request for the certificate information, wherein the request for the certificate information comprises at least the session ID, receiving, from the user certificate system, the certificate information comprising at least a public key, and storing the certificate information, wherein the certificate information stored comprises at least the public key, and wherein the information associated with the certificate is stored associated with the user profile.

In some embodiments, a computer program product for authenticating a user identity using a user certificate system may be provided, the computer program product comprising at least one non-transitory computer-readable storage medium having computer-executable program code instructions stored therein, the computer-executable program code instructions comprising program code instructions for receiving, from a user device over a first network, a request for services from a user profile, configuring an identity confirmation link such that accessing the identity confirmation link causes transmission, from the user device to the user certificate system over a device network, of identification information, wherein the identification information comprises at least identity-linked information, providing the identity confirmation link to the user device, receiving, from the user device, an information preparation notification, wherein the information preparation notification is indicative of an identity message being accessible, on the user certificate system, using a session ID, wherein the identity message is based on certificate information linked to the identity-linked information, transmitting, to the user certificate system, an identification request, wherein the identification request comprises at least the session ID, receiving, from the user certificate system, the identity message comprising an encoded portion, and validating the identity message by decrypting, using a public key associated with the identity linked identifier, the encoded portion of the identity message.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates an example system within which embodiments of the present invention may operate.

FIG. 2 illustrates a block diagram showing an example apparatus for facilitating user identification in accordance with some exemplary embodiments of the present invention.

FIG. 3 illustrates a data flow diagram depicting data flow operations for registering a new user identity with a service provider in accordance with some example systems within which embodiments of the present invention may operate.

FIGS. 4, 5, and 6 illustrate flowcharts depicting example operations for registering a new user identity with a service provider and a user certificate system in accordance with some example embodiments discussed herein.

FIG. 7 illustrates a data flow diagram depicting data flow operations for facilitating user identification in accordance with some example systems within which embodiments of the present invention may operate.

FIGS. 8, 9, and 10 illustrate flowcharts depicting example operations for facilitating user identification in accordance with some example systems within which embodiments of the present invention may operate.

FIG. 11 illustrates another example system within which embodiments of the present invention may operate.

### DETAILED DESCRIPTION

Embodiments of the present invention now will be described more fully hereinafter with reference to the accompanying drawings, in which some, but not all, embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

As used herein, the terms “data”, “content”, “information”, and similar terms, may be used interchangeably to refer to data capable of being captured, transmitted, received, displayed, and/or stored in accordance with various example embodiments. Thus, use of any such terms should not be taken to limit the spirit and scope of the disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, and/or the like, sometimes referred to herein as a “network.” Where multiple networks are described, it will be appreciated that each network in the multiple networks may utilize entirely different components, share some components, share all components, and otherwise be configured such that a first network and a second network may be entirely separate networks, partially the same network, or entirely the same network.

### Overview

PKI certificates facilitate user identity authorization by leveraging cryptographic signatures. Messages, requests, data and other information transmitted over a network may be “signed” by a sender with a secret cryptographic key, creating an encrypted data message. The encryption algorithm used to sign the message is often designed such that the encrypted data message may then be decrypted by a second key corresponding to the sender, and only by that second key. If the recipient successfully decrypts the encrypted data, the recipient knows with certainty that the sender is truly who they claim to be, as they would not have been able to create the encrypted message without controlling the secret cryptographic key.

Systems using asymmetric cryptographic algorithms, such as those leveraging PKI, use two keys to perform this verification. The first key is a private key, which remains controlled by the entity to be verified (e.g., a sender of a message). The private key forms a pair with a public key, such that when a message is signed using the private key, it may be decrypted using the public key, and only using the public key. While the private key must remain secret, the public key may be distributed to a recipient such that the recipient may use it verify messages coming from the sender. To facilitate easy transmission and storage, the public key may be stored in a certificate, which may contain other information such as information associated with the certificate holder, information associated with the entity for which the certificate is verifying, a signature chain used to verify the entities issuing the certificate, and the like. Service providers typically store certificates on their servers that may be used to verify to users that the service provider is who they claim to be. However, users typically do not have certificates associated with them that may provide reciprocal confirmation to the service provider that the user is who they claim to be.

However, service providers often have a need to identify a user for the purpose of providing services and/or billing for services. This means service providers often must rely on alternative methods of confirming a user's identity, such as authorization through a username and password. These methods of confirming a user's identity may cause security problems, as storing user credentials for authorization purposes puts the service provider at risk for security breaches that lead to theft of user credentials. Indeed, over the past few years there have been increasing amounts of large-scale thefts of user credentials on the scale of hundreds of millions in the United States alone. Combining this with the fact that many users reuse their credentials across services has led security experts to conclude that credentials alone are no longer a secure way to authenticate users.

Subsequently, service providers may also utilize second-factor authentication schemes, such as OTP over SMS. However, these systems may require technical expertise that. makes adoption of a second-factor authentication scheme prohibitive. In some instances, second-factor authentication schemes may have security flaws related with them such that using the authentication method is similarly insufficient. Additionally or alternatively, in instances where a second-factor authentication scheme is utilized, the second-factor authentication scheme may be cumbersome, difficult for users to perform, other otherwise diminish a user's experience with the service provider.

Client certificate functionality is built into the TLS protocol and supported by all major web browsers, but similarly has technical expertise required to acquire, install, and manage a client certificate on a web browser along with the access control required to prevent unauthorized use that has severely limited the adoption of this form of user identification. However, certificates are in common use on many other types of electronic devices, such as cable set-top boxes where they provide positive identification of the device to the cable company. While this use of certificates has put an end to the cloning of set-top boxes and the pirating of cable company content, certificates may be installed and reliably managed on cable set-top boxes because they remain under the control of the cable company. At any given time, the cable company knows which of their subscribers is associated to a specific set-top box. If a set-top box is reported stolen by a subscriber or the subscriber terminates service, the cable company can easily shut down access privileges of that set-top box using the certificate.

Other devices, such as the mobile phone, are conspicuously absent. from the types of devices that host certificates. Installing a certificate on a mobile phone, for example, would be of some utility, but it would also be wrought with further problems. For example, while service providers would be able to identify the mobile phone with certainty, if the mobile phone changes hands, such as through sale or theft, the new owner would have access to the certificate of the previous user. Unlike the cable company example, a service provider would not have timely knowledge that a mobile phone's certificate is no longer associated with the user.

However, Applicants have identified that certain information associated with devices may be used as “identity-linked information,” such that the information functions as a proxy for the identity of the device holder. For example, mobile phones have become as ubiquitous as a wallet or purse. Mobile phones are typically kept in close proximity to the user and kept. In control of that user. In the event. of loss or theft, the mobile phone is typically protected by a numeric passcode, a pattern passcode, a fingerprint or other biometric characteristic of the user, or the like. While the user may change to a new phone in the event of a loss or theft, the user retains their phone number. The certainty of the association between the mobile phone number and the device user's identity relies on the security built into the Subscriber Identity Module (SIM) used by the mobile phone carrier to positively identify the user for billing purposes. When a user replaces a SIM card, they often retain their mobile phone number,

Accordingly, embodiments of the present inventions address these problems by creating certificates and linking the certificates to identity-linked information associated with a user identity or user device, such as a mobile-phone number. The certificate(s) created may contain to certificate information, such as a public key, private key, certificate chain/certificate verification information, which may be used to identify the process used to generate the certificate up to a trusted certificate authority, and/or user information such as a name.

The certificates may be stored by a user certificate system and used to generate an identity message, which may allow the service provider to confirm the user identity. For example, in one embodiment a user may request, using their mobile phone, services from a service provider. During account registration with the service provider, service provider may configure a link that, when accessed on the mobile phone, enables access to identity-linked information, such as the mobile phone number, by the user certificate system. In an exemplary embodiment, the link may cause a mobile phone number to be provided, via a header enrichment process. In particular, a packet header enrichment process, in which packet headers comprise device identification information, includes, for example, packet headers “injected” by a trusted party such as a carrier, network provider or through a login process. For example, in some embodiments, one or more network providers may inject a phone number associated with a mobile device within packet headers. In this manner, the user certificate system or in some embodiments, a third party authentication system, may obtain device identification information without user input. Since the mobile phone is likely secured such that only the rightful user of a device associated with a mobile phone number may access it, a carrier may be sure that When a request is made over a device associated with that mobile phone number, it is truly from the user. Thus, the mobile phone number functions as identity-linked information because it serves as a proxy for the user identity itself.

Continuing the example, a mobile phone number is linked to a certificate at the time of registration such that both a public certificate, including a public key, and a private key may be stored by the user certificate system. For subsequent transactions, an identity message may be generated that verities the user identity. For example, a user may later request services from a service provider, such as after they registered their account, and the service provider may require authentication. The service provider may configure a link and transmit it to a user device, such that accessing the link will once again cause transmission of identity-linked information to the user certificate system, such as by a carrier through header enrichment. The user certificate system may then retrieve stored certificate information that is linked to the identity-linked information, and use it to generate an identity message. The identity message serves to confirm that the identity associated with the user has been confirmed by the identity-linked information. So, for example, an identity message may be generated that includes an encrypted portion signed using a private key stored on the user certificate system linked to the identity-linked information. When the identity message is transmitted to the service provider, the service provider may then verify the user's identity has been associated with the identity-linked information, such that verification of the identity message serves as a proxy for the user's identity, by decrypting the encrypted portion using a corresponding public key, such as one received during registration.

In particular, embodiments described herein may be configured to facilitate user identification to a service provider by linking, on a user certificate system, certificate information with identity-linked information, such as a mobile phone number. In some embodiments, the user certificate system may receive the identity-linked information in response to a request for services, such as a request by a user to sign up for a new account with the service provider or a request by a user to add enhanced authentication to their existing account with the service provider. In some embodiments, the certificate information may comprise public certificate information linked to the identity-linked information, and private information, such as a private key, linked to the identity-linked information. In such embodiments, the public certificate information, comprising, for example, a public key, may be provided to a service provider. The public certificate information may be transmitted to the service provider in the form of a digital certificate, such as a X.509 certificate. In some embodiments, the service provider may then store the digital certificate, or at least the public key, with a user profile associated with the user requesting services. In some embodiments, when the user certificate system receives identity-linked information indicating the user needs to be authenticated in response to a request for services from the service provider, the user certificate system may then retrieve the certificate information linked to the identity-linked information, generate an identity message, and use a portion of the certificate information, such as the private key, to cryptographically sign the identity message and transmit the identity message to the service provider. In some embodiments, the user certificate system may additionally provide the public certificate information or a portion of the public certificate information, for example the public key in the form of a digital certificate, to the service provider. In such embodiments, the service provider may a public key associated with the user requesting services, for example a public key stored in a certificate associated with a user profile that made the request for services or a public key received along with the identity message, to decrypt the identity message. Once the service provider successfully decrypts the message using the public key, the service provider can he certain that the user is who they claim to be.

The user certificate system may be generalized to store more than just certificate information. For example, a user certificate system may contain a user identity document repository. Alternatively or additionally, a user certificate system may be associated with a user identity document repository such that the user certificate system may access, modify, and/or delete documents from the repository. A user identity document repository may be configured to store documents, images, and the like associated with identification documents associated with the user, such as a social security card. These documents may similarly he linked to identity-linked information and stored accordingly, such that the user certificate system may retrieve the documents using received identity-linked information.

### Definitions

A person having ordinary skill in the art would understand a “carrier network” refers to a telecoms network infrastructure provided by a telecoms service provider.

The term. “certificate authority” refers to an entity that issues digital certificates. A digital certificate issued by a certificate authority may include certification information associated with identity attestation information. In some embodiments, a certificate authority may receive a certificate signing request from a user certificate system. In some embodiments, a certificate authority may receive a public key, or a public and private key, associated with the certificate signing request. In some embodiments, a certificate authority may generate the public and private key, and include them in the response to the certificate signing request. Additionally, in some embodiments, a certificate authority may provide a digital signature associated with the certificate authority, such that the digital signature can be used to verify that the digital certificate was issued from the certificate authority. A particular certificate authority may be associated with a particular entity type, such as a commercial entity, government entity, and the like.

A certificate authority may be a “trusted certificate authority” if it is considered trustworthy enough for a system to consider certificates issued by the trusted certificate authority as valid. Each certificate authority may have a level of trust associated with it. Certain certificate authorities may be highly trusted duo to their entity type (e.g., government certificate authorities) or due to other factors such as length of operation (e.g., a commercial certificate authority with a long existence may be more trusted than a new commercial certificate authority).

The term “certificate authority verification process” refers to the process a certificate authority utilizes to verify the identity of an entity or person before issuing corresponding certificate information. While a simple verification process may not request any particular identifying information, highly-trusted certificate authorities may require particular verification steps, such as in-person verification, that are highly reliable.

A trusted certificate authority with a highly reliable certificate authority verification process may verify an identity and issue an “ID-VERIFIED certificate”, wherein the ID-VERIFIED certificate is signed by the trusted certificate authority and comprises “ID-VERIFIED information”, The trusted certificate authority issuing the ID-VERIFIED certificate may be trusted sufficiently that parties receiving the ID-VERIFIED certificate it can supplant one or many identification verification documents, which may have been used in the certification authority verification process. For example, a Postal Service may be a certificate authority, and the corresponding verification process may involve an online application and a personal appearance at the post office, where the applicant must produce one or several identity verification documents (e.g., social security card, birth certificate, passport, and the like) to be verified by a Postal Service worker. For a specific example, the verification process may include producing a social security card in an in-person appearance at the post office, Upon completion of this verification process, the Postal Service may issue an ID-VERIFIED certificate, which third-parties and service providers may accept in lieu of a social security card.

The term “certificate information” should be understood to mean information stored in, or associated with, a given certificate. For example, certificate information may include a public key, a portion of a public key, a certificate identifier, identification information, and/or certificate validation information. The term “certificate validation information” would readily be understood to refer to data/information that identifies a certificate authority where the certificate came from, and data information that can be used to verify that the certificate came from the identified certificate authority. In some example embodiments, the certificate validation information may be “chained” together, such that the generation of the certificate may be validated up to a trusted certificate authority.

The term “device possession confirmation event” refers to receiving information on the user device such that the information received, such as information resulting from a user interaction or received automatically, verifies that the user interacting with the user device is an authenticated user. For example, in some embodiments, a device possession confirmation event may involve receiving, on the user device or another user device, a one-time password sent over SMS to the mobile phone number associated with an authenticated user. Alternatively, a device possession confirmation event may involve receiving, on the user device or another user device, a passcode associated with the user device, a second device, or a dedicated passcode device. In some embodiments, the device possession confirmation event may involve receiving, on the user device or another user device, a biometric indicator (e.g., a retina scan, fingerprint, facial recognition scan, or the like) and matching that biometric indicator with that of the authenticated user. In some embodiments, the device possession confirmation event may cause a service provider to provide information attesting that the user device is associated with an authenticated user (e.g., a mobile carrier attesting that the phone number associated with the user device is controlled by the authenticated user).

The term “document action” refers to any action for managing a collection of documents in a user identification document repository. For example, an example embodiment may support the document actions of (1) adding an identification document to the user identification document repository, (2) deleting the identification document from the user identification document repository, and (3) distributing an identification document from the user identification document repository.

The term “header enrichment” refers to a process for authenticating a mobile device or an owner of the mobile device via a Direct Autonomous Authentication process, involving a packet header enrichment in which packet headers comprise device identification information, for example, “injected” therein by a trusted party such as a carrier, network provider or through a login process. For example, in some embodiments, a network 118 may inject a phone number associated with a mobile device within packet headers. In this manner, the authentication system may obtain device identification information without user input. application Ser. No. 15/424,595, entitled “Method and Apparatus for Facilitating Frictionless Two-Factor Authentication,” filed on Feb. 3, 2017, which is hereby incorporated by reference in its entirety, describes a number of exemplar processes for performing a Direct Autonomous Authentication process.

One having ordinary skill in the art would recognize that a “hardware security module” (or “HSM”) refers to a physical device or module that safeguards digital keys. Additionally, a may be configured to generate cryptographic keys. Security in a certificate environment using the Public Key infrastructure (“PKI”) hinges on the security of private keys corresponding to their respective public counterpart. Accordingly, HSMs are any module designed to store one or more digital keys in a highly secure manner, wherein the digital keys are highly secure both digitally and physically.

The term “identity verification document” refers to any document that can be used to verify an identity of a user/entity, or contains identification information associated with the identity of the user/entity. For example, an identity verification document may include a social security card, birth certificate, driver's license, national identification card, and the like,

The term “identification information” should be understood to refer to information that, alone or in combination with other identification information, identifies a particular user/entity. For example, identity information may include a name, a phone number, a social security number, a birthday, an identification number, or the like. In some embodiments, identification information may be sent from a user device to a user certificate system, or from a service provider to a user certificate system, which may store all or part of the identification information associated with, or as part of, public certificate information.

The term. “identity-linked information” refers to any information related to a user device that functions as a proxy for user identification if the user device is accessible to a user. For example, in an example embodiment, identity-linked information may identify a mobile phone number.

The term “identity message” refers to a message that may be used to authenticate a user identity. In some embodiments, the identity message may comprise an encoded portion, wherein the encoded portion may be encrypted using a private key associated with a certificate linked to the identity-linked information. Accordingly, a service provider or third-party may use a corresponding public key, such as a public key previously stored through a user registration process or a public key included in an unencrypted portion of the identity message, to decrypt the encrypted portion of the identity message. In some example embodiments, the identity message may comprise, additionally or alternatively, a set of identification information associated with the user identity. The public key and/or set of identification information may be sent in the identity message in the form of a certificate, such as a X.509 certificate.

The term “information preparation notification” refers to a transmission or request that is indicative that information has been. retrieved for use in. an identity message. For example, in some embodiments, a user certificate system may transmit, or cause transmission of, an information preparation notification to a service provider, such that the service provider is notified that the user certificate system has retrieved information linked to previously sent identity-linked information and the user certificate system is prepared to generate and/or transmit an identity message using the retrieved information. In some embodiments, an information preparation notification may be indicate that the identity message is accessible using a session ID, in some example embodiments, a user certificate system may cause transmission, from a user device to a service provider, of an information preparation notification by transmitting, to the user device, a response to an earlier sent request. In some embodiments, the response may comprise the session ID.

The term “ledger” refers to a log of transactions, such as a log of transaction reports, wherein the log of transactions allows auditing by authorized parties. In some embodiments, the ledger may be stored in a transaction database, in an additional embodiment, the ledger may be stored via a blockchain, such that each new transaction reports is appended to the end of the chain,

The term “linking completed notification” refers to a transmission or request that is indicative that user certificate information is accessible using a session ID. In some embodiments, a user certificate system may successfully link user certificate information to be linked with identity-linked information, or cause such information to be linked, and upon successfully linking such information transmit, or cause transmission of, a linking completed notification from a user device to a service provider. In some example embodiments, a user certificate system may cause transmission of a linking completed notification by transmitting, to a user device, a response to an earlier sent request. In some embodiments, the response to the request may comprise a session ID that may be used in accessing the certificate information.

The term “network” refers to one or more servers, relays, routers, network access points, base stations, and/or the like, capable of transmitting information and/or requests between computing devices. For example, in some embodiments, a network may be a mobile carder network, In another embodiment, a network may refer to a Wi-Fi network, WLAN, LAN, WAN, or the like. In some embodiments, a “first network” and a “second network” may refer to two separate networks. Alternatively, in some embodiments, a “first network” and a “second network.” may refer to the same network, such. that the first and second networks transmit information over some shared components or all shared components. Further, in some embodiments, a “first network” and a “second network” may be used to indicate that the two networks are out-of-band with respect to one another.

One having ordinary skill in the art would readily recognize the term “out-of-band” refers to a network or data channel that is separate from a primary network or data channel. For example, in some embodiments, a device network may be out-of-band from a communications network. In some embodiments, the device network may be a carrier network while the communications network may be a Wi-Fi or WLAN network.

A “service provider” refers to any entity that provides services to a user via a user device. For example, a service provider may be an online retailer, software as a service provider, other e-commerce business, or the like. A service provider may be associated with “service provider identification information” that uniquely identifies the service provider. For example, service provider identification information may comprise a combination of attributes associated with service provider (e.g., a service provider name, location, or the like) or may comprise an identification number provided by the service provider or generated by the user certificate system. Service provider identification information may be used to associate a particular service provider with a particular user certificate, such that different user certificates may be associated with different service providers.

The term “session ID” should be understood to refer to information that identifies a particular request from a user device. For example, in some embodiments, a user device may receive from a third-party device or system, generate, or otherwise determine a session ID before requesting services from a service provider. In such embodiments, the user device may subsequently forward the session ID to the service provider, such as in the request for services, and forward the session ID to the user certificate system, such as part of a request. In some example embodiments, the service provider may receive from a third-party device or system, generate, or otherwise determine a session ID, which the service provider may subsequently forward to the user device, such as in a response to a request for services, and cause the user device to forward the session ID to the user certificate system, such as by configuring a link that may, upon accessing the link on the user device, cause a request from the user device to the user certificate system that includes at least the session ID, In such embodiments, the service provider already has access to the session ID, the session ID may effectively be forwarded to the user certificate system using the user device. In some embodiments, the user certificate system may receive from a third-party device or system, generate, or otherwise determine a session ID. In such embodiments, the user certificate system may forward the session ID to the user device by including it in a response notification sent to the user device, such as a response to a request received by the user certificate system, and cause the session ID to be sent from the user device to a service provider, such as by causing the user device to include the session ID as part of a completed linking notification or an information preparation notification.

The term “transaction report” should be understood to refer to information that uniquely memorializes a transaction or transmission of data between a first system and a second system. For example, in an example embodiment, a transaction report may be generated that uniquely memorializes a transmission, to a service provider, of a portion of certificate information linked to identity-linked information. In an additional embodiment, a transaction report may be generated that uniquely memorializes transmission of an identity message to a service provider.

The term “user certificate repository” refers to a repository where public user certificates or public user certificate information is stored. In some example embodiments, a user certificate repository may store public certificate information in the form of a X.509 certificate. In some embodiments, a user certificate repository may store user certificates comprising at least a public key. In additional embodiments, a user certificate repository may store a set of user certificates, wherein each user certificate comprises a public key and a set of identification information associated with a user identity linked to the user certificate by identity-linked information. Highly secure information, such as a private key associated with a public key for a given certificate, should be stored in a HSM rather than in the user certificate repository.

The term “user certificate system” refers to a system comprising a hardware security module storing at least a private key associated with a user certificate, and a user certificate repository storing the user certificate. In some example embodiments, the user certificate system may store additional information, such as additional identification information, in the user certificate repository, such as by including the additional identification information in or associated with the user certificate. In another example embodiment, the user certificate system may additionally be configured to access, or may comprise, a user identity document repository.

The term “user device” refers to a device (e.g., a mobile device) configured to interact with a service provider, a user certificate system, and/or other user devices through one or more networks. Examples of a user device may include a laptop, mobile device (e.g., smartphone and other mobile devices), tablet, personal computer, chip embedded card, credit card, debit card, key fob, or the like, or any combination thereof. In an example embodiment, the user device may be configured to request services from a service provider, receive a link in a response from the service provider, transmit a request to a user certificate system by accessing the link, receive a response from the user certificate system, transmit a notification to the service provider of the response from the user certificate system wherein the notification identifies a session ID the service provider can use to access information from the user certificate system. Alternatively, or additionally, the user device may be configured to communicate with another user device, such as to perform a device possession confirmation event and/or to contact the service user certificate system. For example, a first user device (e.g., a laptop) may request services from a service provider from a user profile. In response, the service provider may provide a link to a second user device (e.g., a smartphone) associated with th user profile. The user may then interact with the second user device to access the link and transmit a request to the user certificate system. The second user device may then receive a response from the user certificate system, and notify the first user device to cause a notification from the first user device to the service provider. Additionally, or alternatively, a second device may receive information useful in completing a device possession confirmation event, such as a SMS message comprising a one-time password. Alternatively, the second device may display an interface prompting user interaction to complete a device possession confirmation event, for example an interface configured to receive and verify a biometric indicator matches with a biometric indicator associated with the user identity.

The term “user identification document repository” refers to a document repository module associated with the user certificate system. In an example embodiment, the user identification document repository may be configured to store identity documents (e.g., social security card, birth certificate, national identification card, and the like). In some embodiments, the user certificate system may additionally comprise the user identification document repository. Alternatively, in some embodiments, the user identification document repository may be separate from the user certificate system, and accessed through a third-party, for example an identity document management service provider.

### Technical Underpinnings and Implementation of Exemplary Embodiments

A user identity authorization system in accordance with an embodiment of the invention herein facilitates authorization of a user to a service provider by linking identity-linked information with user certificate information, comprising at least a public key and a private key, on a user certificate system. The user certificate system may then utilize at least the private key to generate an identity message that the service provider may validate using the corresponding public key, so as to verify the identity of the user associated with the identity-linked information.

When a user requests services from a service provider they have a user account with, the service provider often has no assurances the user requesting the services is who they claim to be. Conventional systems either rely on storing user credentials, which may be the subject of a security breach, or second-factor authentication methods that may be technically difficult to implement or cumbersome for the user

Embodiments described herein facilitate authenticating a user requesting services from a service provider by linking identity-linked information with certificate information in a user certificate system. In particular, various embodiments herein are directed to linking, on a user certificate system, identity-linked information with certification information, comprising at least a public key and a private key, in response to a user device requesting services from a service provider, enabling the user certificate system to provide the public key to the service provider. Further in particular, various embodiments enable a user certificate system to retrieve information linked to the identity-linked information, such as the private key, generate an identity message using at least the retrieved information, sign the identity message by encrypting at least a portion of the identity message using the private key, and transmit the identity message to the service provider such that the service provider may verify the identity of the user requesting services by decrypting the encrypted portion of the identity message using the public key.

### System Architecture

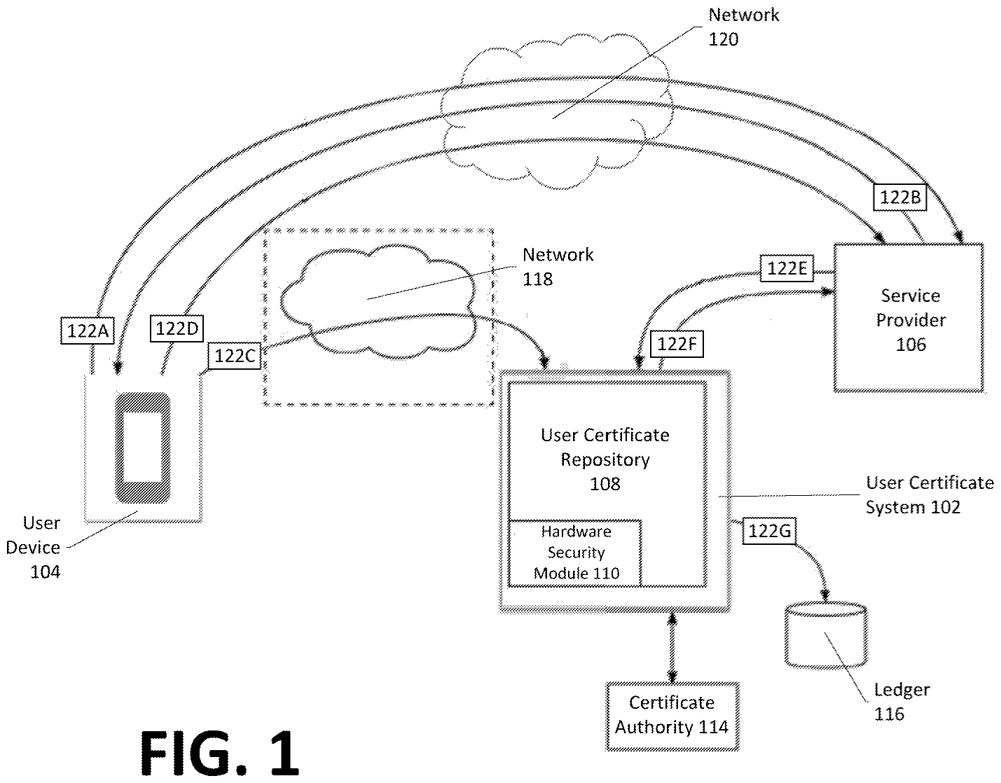

FIG. 1 is a system diagram showing an exemplary system, which may include one or more devices and sub-systems that are configured to implement embodiments discussed herein, and in particular, to implement a user registration process with a user certificate system and user authentication via a user certificate system.

Turning to the FIG. 1, the system may include a user device 104, service provider 106, and user certificate system 102. User certificate system 102, user device 104, and service provider 106, may include any suitable network server and/or other type of processing device to communicate with other devices via one or more networks, such as user device 104, service provider 106, and certificate authority 114.

User device 104 may be configured to communicate with service provider 106 over a network, such as network 120, which may be the Internet or the like. User device 104 may be configured to communicate with user certificate system 102 over a network, such as network 118. Network 118 may be the same as network 120. Alternatively, network 118 may be a network out-of-band with respect to network 120, so as to enhance security by preventing device-based and channel-based cyber-attacks.

In some embodiments, user certificate system 102 may be configured to communicate with certificate authority 114. Certificate authority 114 may be configured to generate certificate information, such as a public key and a private key, and transmit it to user certificate system 102. In some embodiments, user certificate system 102 may include processing devices configured to generate certificate information. User certificate system 102 may also be configured to link the certificate information to identity-linked information, such as identity-linked information received over network 118 from user device 104.

User certificate system 102 may include, for example, user certificate repository 108 and hardware security module 110. User certificate system 102 may be configured to store public user certificate information, such as, for example, public key(s), certificate validation information, and the like, in user certificate repository 108. In some embodiments, user certificate repository 108 may additionally store user information, such as a name, birthday, and the like, associated with identity-linked information. User certificate system 102 may be configured to store private certificate information, such as a private key, in hardware security module 110.

In some embodiments, user certificate system 102 may be configured to store information in ledger 116. In some embodiments, user certificate system 102 may include ledger 116, and user certificate system 102 may be configured to include transaction reports in ledger 116. In some embodiments, ledger 116 may be a list, database of records, or other implementation to facilitate tracking a list of transactions. In some embodiments, ledger 116 may comprise a blockchain implementation, wherein the user certificate system 102 may be configured to append transaction reports to the blockchain or submit transaction reports to be appended to the blockchain.

In some embodiments, the components illustrated and described above may be configured to implement multiple operations in accordance with example embodiments of the present invention. For example, the user device 104 may be configured to request services from service provider 106, receive a link from service provider 106, access the link, cause transmission of identity-linked information to user certificate system 102, receive a notification from user certificate system 102, and notify service provider 106. User certificate system 102 may be configured to receive identity-linked information, such as from a carrier using header enrichment over network 118, cause generation of a user certificate and linking with identity-linked information, generate an identity message using certificate information, notify service provider 106 of a completed action, such as through notifying user device 104, and provide information, such as a certificate or identity message, to service provider 106.

In some embodiments, the several components may be configured to communicate in the manner illustrated by blocks 122A-122G. In some embodiments, the user device 104 may transmit a request 122A. to service provider 106 over a first network 120. Request 122A may be a request for services, such as to register a new user account, enhance authentication associated with a user account, or the like. In response to the request, service provider 106 may transmit a response 122B. The response 122B may include a link, such as a GET link or other HTTP or HTTPS link. The link may be configured such that accessing the link on the user device transmits identification information 1220 from the user device 104 to the user certificate system 102 over a second network 118. In an example embodiment, network 118 may be an out-of-band network with respect to network 120, for example network 120 may be an Internet network and network 118 may be a carrier network. In such an embodiment, facilitating transmission 1220 over an out-of-band network prevents device-based and channel-based cyber-attacks. In some embodiments, network. 118 and network 120 may be partially or entirely the same network.

In some embodiments, transmission 122C may comprise identity-linked information, such as, for example, a mobile phone number associated with user device 104. In some embodiments, transmission 122C may have identity-linked information added to it by a third-party after the user device begins the transmission, such as by a mobile carrier using header enrichment.

In some embodiments, user certificate system may be configured to, in response to receiving transmission 122C, perform an action for preparing data on the user certificate system 102 in preparation for a request from service provider 106. User device 104 may then transmit notification 122D to service provider 106. In some embodiments, notification 122D may be indicative that user device 104 successfully completed transmission 122C to user certificate system 102, or may be indicative that user device 104 received a response from user certificate system 102 in response to transmission 122C, such that.

In some embodiments, service provider 106 may be configured to, in response to receiving notification 122D, transmit request 122E to user certificate system 102. In some embodiments, request 122E may request certificate information associated with from user certificate system 102. In other embodiments, request 122E may request an identity message from user certificate 102. In response to receiving request 122E, the user certificate system 102 may be configured to prepare certificate information, such as public certificate information including a public key, for transmission to service provider 106.

The user certificate system then may transmit information 122F to service provider 106. in some embodiments, information 122F may include certificate information linked with the identity-linked information. In such embodiments, service provider 106 may be configured to store information 122F, or a portion thereof, associated with a user profile/user account, in some embodiments, after transmitting information 122F to service provider 106, user certificate system 102 may be configured to store a transaction report 122G in ledger 116. In such embodiments, the transaction report 116 may uniquely identify the transmission of information 122F from user certificate system 102 to service provider 106.

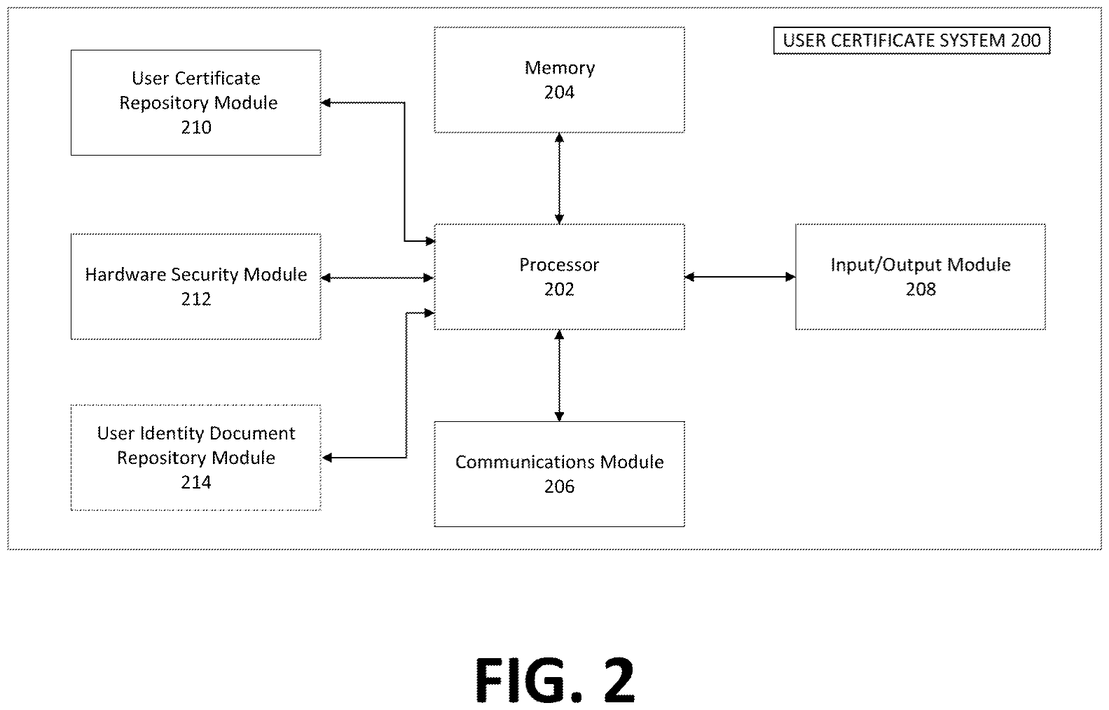

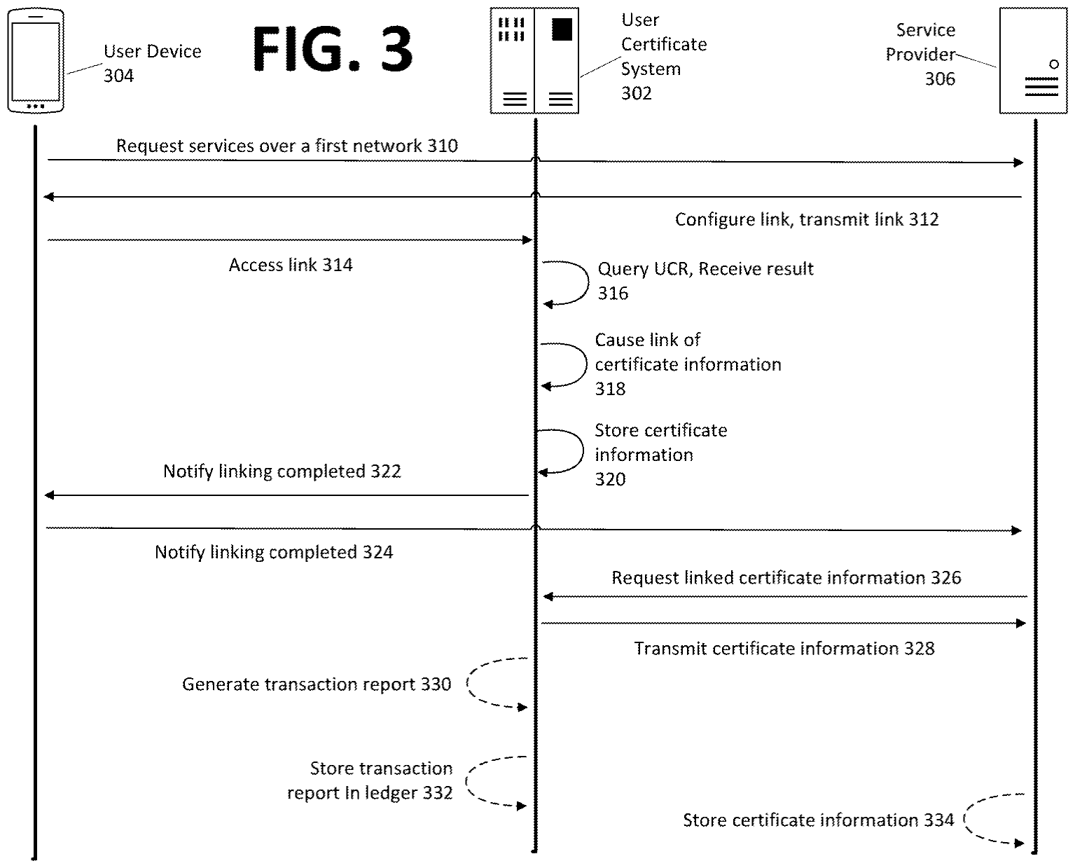

User certificate system 102 may be embodied by one or more computing systems, such as apparatus 200 shown in FIG. 2. As illustrated in FIG. 2, the apparatus 200 may include a processor 202, a memory 204, a communications module 206, input/output module 208, a user certificate repository module 210, and a hardware security module 212. Additionally, in some embodiments, the apparatus 200 may additionally include a user identity document repository module 214. The apparatus 200 may be configured to execute the operations described above with respect to FIG. 1, and below with respect to FIGS. 3-10. Although these components 202-214 are described with respect to functional limitations, it should be understood that particular implementations necessarily include the use of particular hardware. lit should also be understood that certain of these components 202-216 may include similar or common hardware. For example, two sets of circuitry may both leverage use of the same processor, network interface, storage medium, or the like to perform their associated functions, such that duplicate hardware is not required for each module. The use of the term “module” as used herein with respect to components of the apparatus should therefore be understood to include particular hardware configured to perform the functions associated with the particular module as described herein.

The term “module” should be understood broadly to include hardware and, in some embodiments, software for configuring the hardware. For example, in some embodiments, “module” may include processing circuitry, storage medium, network interfaces, input/output devices, and the like. In some embodiments, other elements of the apparatus 200 may provide or supplement the functionality of a particular module, or particular modules. For example, the processor 202 may provide processing functionality, the memory 204 may provide storage functionality, the communications module 208 may provide network interface functionality, and the like.

In some embodiments, the processor 202 (and/or co-processor and any other processing module assisting or otherwise associated with the processor) may be in communications with the memory 204 via a bus for passing information among components of the apparatus. The memory 204 may be non-transitory and may include, for example, one or more volatile and/or non-volatile memories. In other words, for example, the memory may be an electronic storage device (e.g., a computer readable storage medium). The memory 204 may be configured to store information, data, content, applications, instructions, or the like, for enabling the apparatus to carry out various functions in accordance with example embodiments of the present invention.

The processor 202 may be enabled in a number of different ways and may, for example, include one or more processing devices configured to perform independently. Additionally or alternatively, the processor may include one or more processors configured in tandem with a bus to enable independent execution of instructions, pipelining, and/or multithreading The use of the term “processing module” may be understood to include a single core processor, a multi-core processor, multiple processors internal to the apparatus, and/or remote or “cloud” processors.

In an example embodiment, the processor 20 may be configured to execute instructions stored in the memory 204 or otherwise accessible to the processor. Alternatively or additionally, the processor may be configured to execute hard-coded functionality. As such, whether configured by hardware or software methods, or by a combination thereof, the processor may represent an entity (e.g., physically embodied in the circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output module 206 that may, in turn, be in communication with processor 202 to provide output to the user and, in sonic embodiments, to receive an indication of a user input. The input/output module 206 may comprise a user interface and may include a display and may comprise a web user interface, a mobile application, a. client device, a kiosk, or the like. In some embodiments, the input/output module 206 may also include a keyboard, a mouse, a touch screen, touch areas, soft keys, a microphone, a speaker, or other input/output mechanisms. The processor and/or user interface module comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In regard, the communications module 208 may include, for example, a network interface for enabling communications with a wired or wireless communication network. For example, the communication module 208 may include one or more network interface cards, antennae, buses, switches, routers, modems, and supporting hardware and/or software, or any other device suitable for enabling communications via a network. Additionally or alternatively, the communications interface may include the circuitry for interacting with the antenna(s) to cause transmission of signals via the antenna(s) or to handle receipt of signals received via the antenna(s).

User certificate repository module 210 includes hardware and software configured to facilitate storage of public certificate information linked to identity-linked information. Additionally or alternatively, user certificate repository module 210 may he configured to store additional information, such as user information associated with a user identity, linked to identity-linked information. User certificate repository module 210 may be configured to store information in one or more data formats, such as X.509 format. User certificate repository module 210 may receive information via a network interface provided by the communications module 208. However, it should also be appreciated that, in some embodiments, the user certificate repository module 210 may include a separate processor, specially configured field programmable gate array (FPA), or application specific interface circuit (ASIC) to perform the reception of information to be stored in the user certificate repository module 210. User certificate repository module 210 is therefore implemented using hardware components of the apparatus configured by either hardware or software for implementing these planned functions,

Hardware security module 212 includes hardware and software configured to facilitate storage, safeguarding, and management of digital keys linked to identity-linked information. Additionally or alternatively, hardware security module 212 may he configured to store a private key linked to identity-linked information. Hardware security module 212 may receive information via a network interface provided by the communications module 208. However, it should also be appreciated that, in some embodiments, the hardware security module 212 may include a separate processor, specially configured field programmable gate array (FPA), or application specific interface circuit (ASIC) to perform the reception of information to be stored in the hardware security module 212. Hardware security module 212 is therefore implemented using hardware components of the apparatus configured by either hardware or software for implementing these planned functions.

In some embodiments, a user certificate system such as user certificate system 200 may include a user identity repository module 214. User identity document repository module 214 includes hardware and software configured to facilitate storage of identity documents, images of identity documents, and/or other files representing identity documents. Documents and/or files may be stored in the user identity document repository module 214 linked to identity-linked information. Additionally or alternatively, user identity document repository module 214 may be configured to add, delete, or release stored identity documents, images of identity documents, and/or other files representing identity documents to third-parties. User identity document repository module 214 may receive information, documents, or other data for storage via a network interface provided by the communications module 208, However, it should also be appreciated that, in some embodiments, the user identity document repository module 214 may include a separate processor, specially configured field programmable gate array (FPA), or application specific interface circuit (ASK) to perform the reception of information to be stored in the user document repository module 214. User identity document repository module 214 is therefore implemented using hardware components of the apparatus configured by either hardware or software for implementing these planned functions.

As will be appreciated, any such computer program instructions and/or other type of code may be loaded onto a computer, processor, or other programmable apparatus' circuitry to produce a machine, such that the computer, processor other programmable circuitry that execute the code on the machine created the means for implementing various functions, including those described herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Example Operations for Implementing Embodiments of the Present Invention

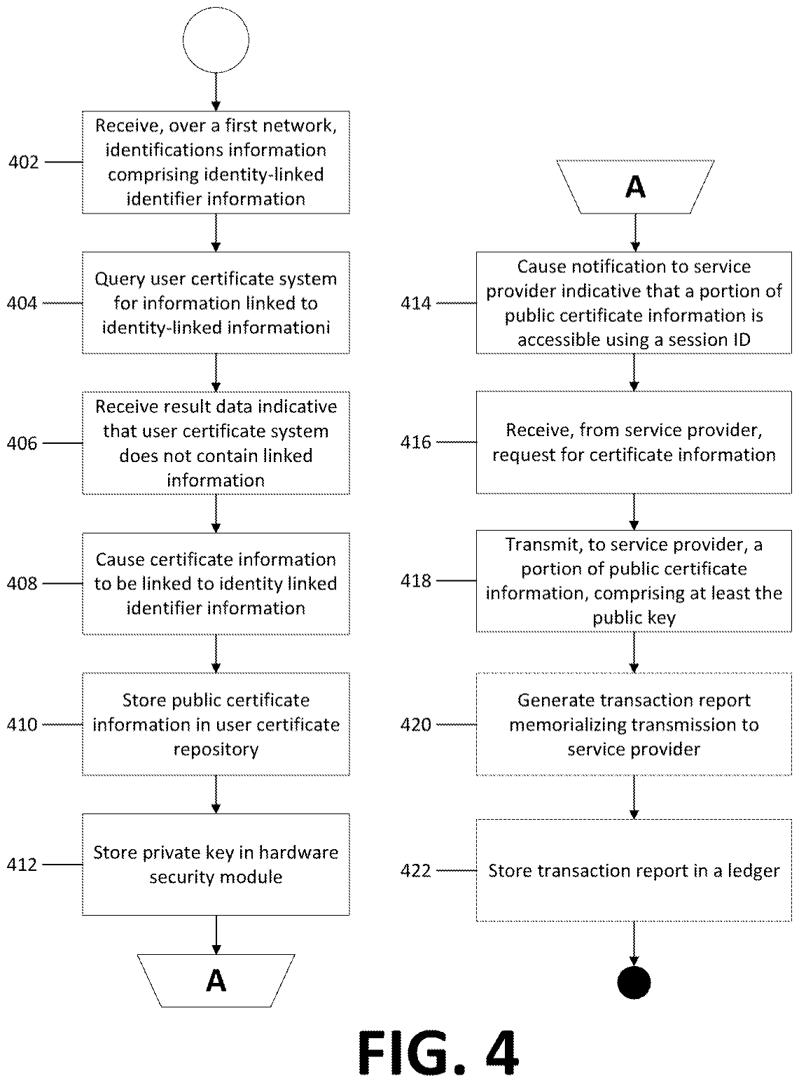

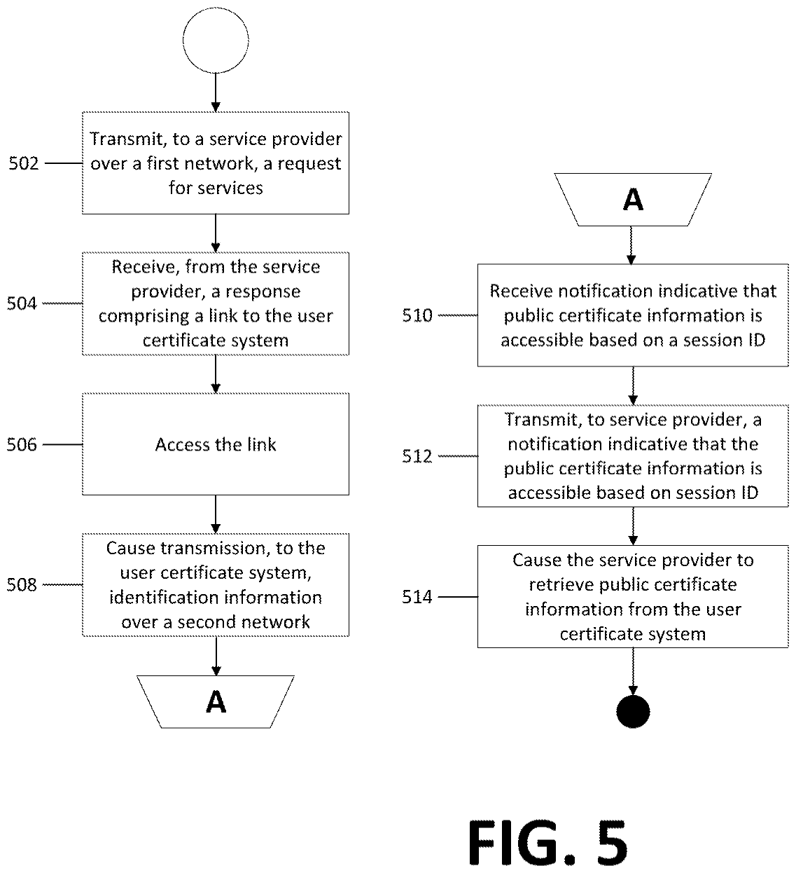

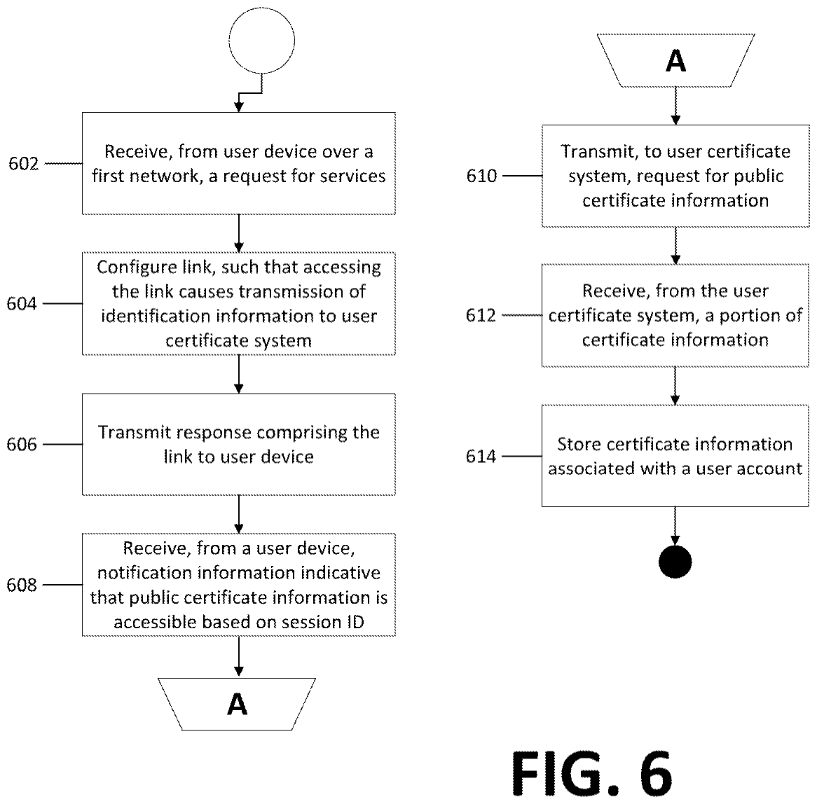

In some embodiments, the system may be configured to implement a user registration process, such that the user registration process registers a user identity with a user certificate system using identity-linked information, and registers the user identity with a user account associated with a service provider by providing certificate information, such as public certificate information comprising a public key, to the service provider. In some embodiments, the system may be configured for facilitating, to a service provider, authentication of a user identity associated with a user device by receiving, on a user certificate system, identification information including identity-linked information and transmitting, from a user certificate system. to the service provider, an identity message comprising an encrypted portion signed using a private key linked with the identity-linked information such that the identity message may be validated using a corresponding public key. FIG. 3 illustrates a data flow diagram depicting data flow operations for a registration process, the registration process linking, on a user certificate system, certificate information with identity-linked information, and transmitting certificate information to a service provider, such as for storage associated with a user account. FIG. 4 illustrates flowcharts depicting example operations for a registration process, such as the registration process illustrated by FIG. 3, from the perspective of a user certificate system, such as user certificate system 302. FIG. 5 illustrates flowcharts depicting example operations for a registration process, such as the registration process illustrated by FIG. 3, from the perspective of a user device, such as the user device 304. FIG. 6 illustrates flowcharts depicting example operations for a registration process, such as the registration process illustrated by FIG. 3, from the perspective of a service provider, such as the service provider 306.

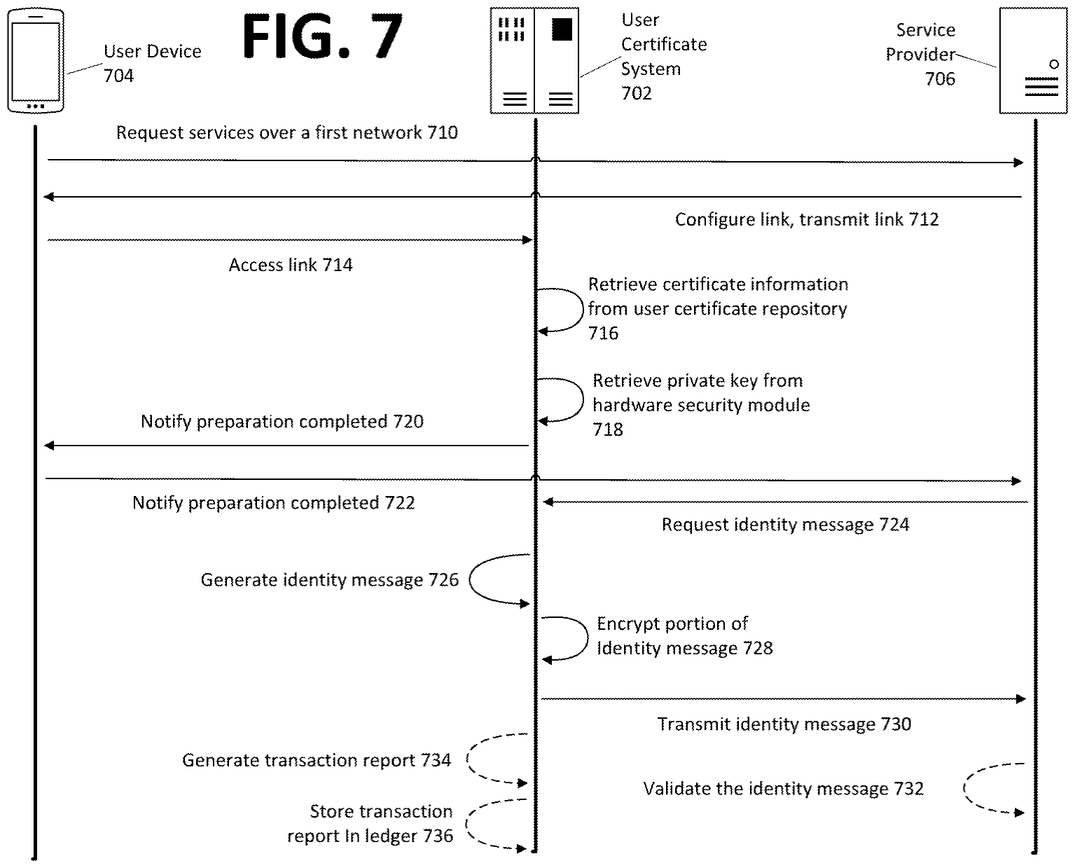

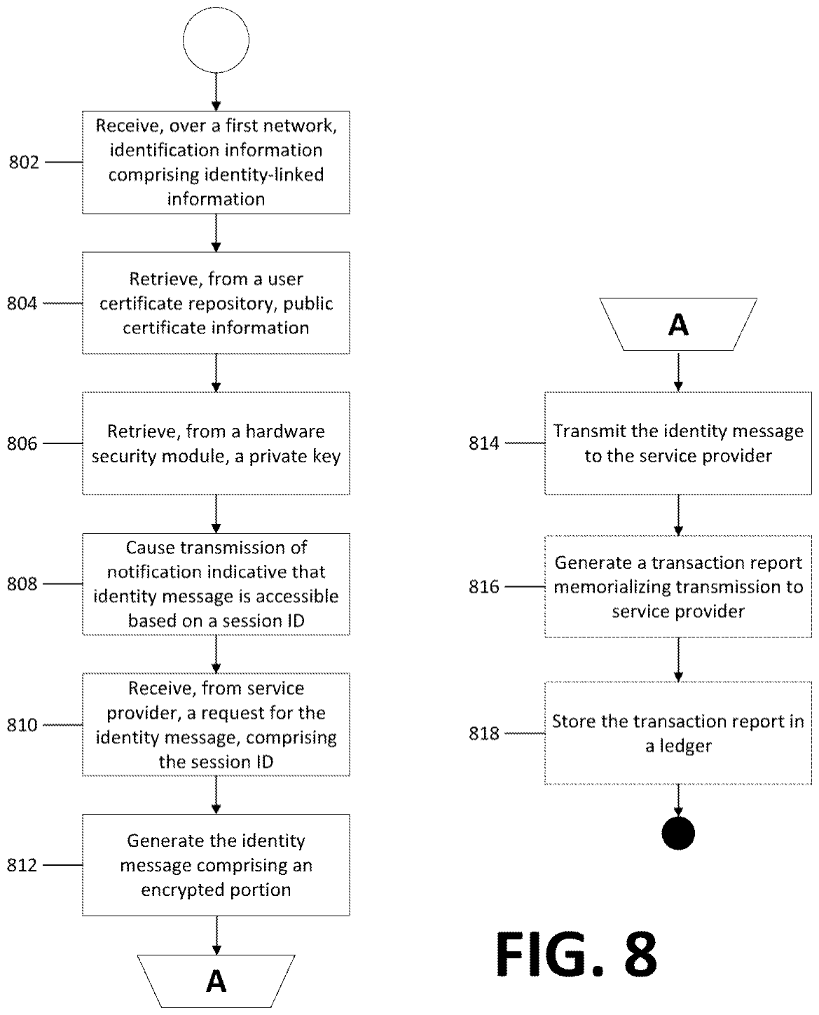

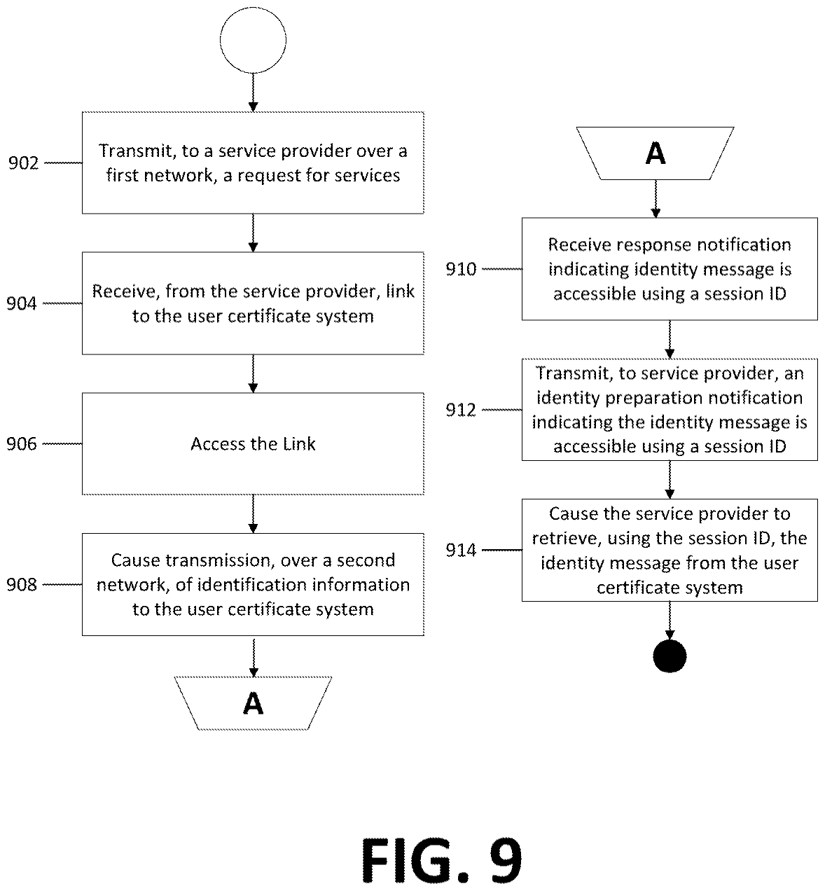

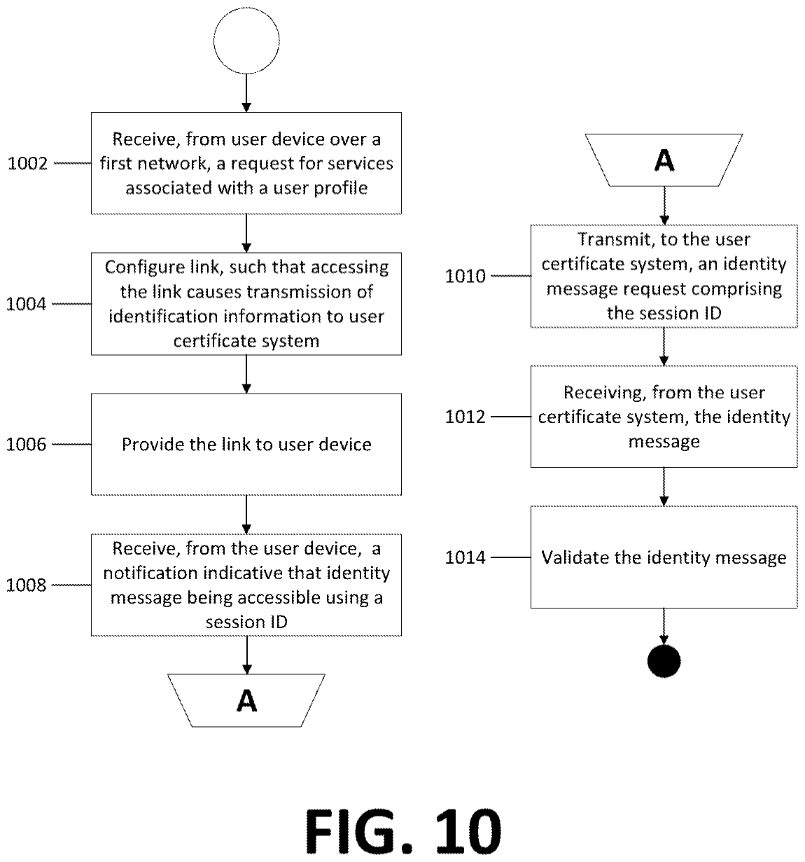

FIG. 7 illustrates a data flow diagram depicting data flow operations for a user identification process, the user identification process retrieving, on a user certificate system, certificate information, comprising at least public certificate information and a private key, with identity-linked information, generating, on a user certificate system, an identity message comprising an encoded portion encrypted using at least the private key, and transmitting the identity message to a service provider, such that the service provider may validate the identity message using a public key associated with the private key. FIG. 8 illustrates flowcharts depicting example operations for a user identification process, such as the user identification process illustrated in FIG. 7, from the perspective of a user certificate system, such as user certificate system 702. FIG. 9 illustrates flowcharts depicting example operations for a user identification process, such as the user identification process illustrated in FIG. 7, from the perspective of a user device, such as the user device 704. FIG. 10 illustrates flowcharts depicting example operations for a user identification process, such as the user identification process illustrated in FIG. 7, from the perspective of a service provider, such as the service provider 706.

### Linking Identity-Linked information with Certificate Information During User Registration

FIG. 3 illustrates a data flow diagram depicting data flow operations for a registration process, the registration process comprising receiving, on a user certificate system 302, identity-linked information, linking certificate information with identity-linked information associated with a user device 304, and transmitting the certificate information to a service provider 306, such as for storage associated with a user account.

At 310, user device 304 requests services from service provider 306. The requests for services may include, for example, a request to register a new account with service provider 306 or a request to enhance authentication to an existing user profile associated with a user account with service provider 306. In some embodiments, the request made at 310 may additionally include a session ID generated by the user device 304 or received by the user device 304 from a third-party device, system, or component. At 312, in response to receiving the request for services 310, service provider 306 may configure a link to access user certificate system 302, and transmit the link to user device 304. In some embodiments, the link may be configured to transmit information to user certificate system 302, such as identification information including identity-linked information. In some embodiments, the link may be configured to additionally transmit a session ID generated by the service provider 306 or received by the service provider 306 from a third-party device, system, or component and transmitted to the user device at step 312. In some embodiments, the link may be provided to user device 304 through SMS. In some embodiments, the link may be provided to user device 304 along with a local device message, for example an operating system message or application message, which may also query the for confirmation.

At 314, user device 304 may access the link configured and transmitted in 312. In some embodiments, the user device 304 may access the link in response to user engagement with the link, and provide identification information to the user certificate system 302. In some embodiments, the user device 304 may access the link via a redirect or redirects, such as HTTP redirects.

In some embodiments, in response to accessing the link at 314, the user device 304 may cause transmission of identification information to user certificate system 302. In some embodiments, the user device 304 may identification information, such as include identity-linked information, in a transmission at step 314. Alternatively or additionally, a third-party, such as, for example, a mobile carrier (not shown) may include identification information in as transmission to user certificate system 302, such as identity-linked information, for example a mobile phone number, through header enrichment.

After receiving the identification information comprising at least the identity-linked information, the user certificate system 302 may prepare certificate information for access, such as through steps 316-320. At 316, the user certificate system may query for information stored on the user certificate system 302 that is linked to identity-linked information, and receive a result indicative of a determination that the user certificate system does not contain information linked to the identity-linked information. At 318, user certificate system 302 causes certificate information to be linked to the identity-linked information. In some embodiments, the certificate information may comprise public certificate information, which may comprise at least public key. Additionally or alternatively, in some embodiments, the certificate information may comprise private certificate information, which may comprise at least a private key. In some embodiments, the user certificate system 302 may be configured to generate the certificate information. In some embodiments, the user certificate system 302 may be configured to cause a certificate authority to generate certificate information, and the user certificate system 302 may be configured to receive the certificate information from the certificate information from the certificate authority. At 320, the user certificate system 302 may link the certificate information. with the identity-linked information and store the certificate information. In some embodiments, the user certificate system 302 may store the public certificate information comprising at least a public key associated with the identity-linked information in a user certificate repository, and may store the private certificate information comprising at least a private key associated with the identity-linked information in a hardware security module.

In some embodiments, a user may request services from a first user device, such as a laptop, associated with a second user device, such as a mobile phone, that may be used for linking user certificate information to identity-linked information. In an example embodiment, a device possession confirmation event may be used to confirm a user's possession of the second user device. In an example embodiment, the device possession confirmation event may be a message, such as a SMS message, sent to the second user device containing the configured link. In some alternative embodiments, other methods may be employed to link a user identity, or a device they possess, to the certificate information. In some embodiments, these methods may include sending a one-time password over SMS to a user device, entering a code on a user device from a device or application running the time-based one-time password algorithm, entering a code on a user device from a device or application running the HMAC-based one-time password algorithm, such as Google Authenticator or Authy Authenticator, using a FIDO key on a user device, or other methods.

At 322, the user certificate system 302 may transmit, to user device 304, a notification indicative of at least a portion of the public certificate information being accessible using a session ID. At 324, in response to receiving the notification transmitted at 322, user device 304 may similarly transmit, to service provider 306, a notification indicative of at least a portion of the public certificate information being accessible using a session ID.

At 326, in response to receiving the notification at 324, service provider 306 may transmit, to the user certificate system 302, a request for the prepared certificate information linked to the earlier sent identity-linked information, the request comprising at least the session ID. At 328, the user certificate system 302 may transmit, to the service provider 306, at least a portion of the public certificate information linked to the identity-linked information, wherein the portion of the certificate information comprises at least the public key.

In some embodiments, the service provider 306 may receive certificate information comprising at least the public key and store the received certificate information at 334. In some embodiments, the service provider 306 may store the received certificate information associated with a user profile used to make the request for services from the user device in 310. In such embodiments, the service provider may utilize the stored certificate information comprising at least the public key to decrypt a portion of an identity message to verify a user identity.

In some embodiments, at 330, the user certificate system 302 may he further configured to generate a transaction report. In such embodiments, the transaction report may uniquely memorialize the transmission of the portion of certificate information from the user certificate system 302 to service provider 306. At 332, in sonic embodiments, the user certificate system 302 may be configured to store the transaction report generated in 330 in a ledger. In some embodiments, the ledger may be a blockchain associated with the user certificate system 302 such that the user certificate system 302 may append new transaction reports to the blockchain.

FIGS. 4, 5, and 6 illustrate an exemplary set of operations performed in accordance with an embodiment of the present invention. Specifically, each of the FIGS. 4, 5, and 6 illustrates an exemplary set of operations performed by one of the systems user device 304, user certificate system 302, or service provider 306, such as an embodiment system functioning as shown in FIG. 1 and described in FIG. 3.

Turning now to FIG. 4, which illustrates a set of operations performed by a user certificate system, such as a user certificate system 302, in accordance with an exemplary embodiment of the present invention. At block 402, the user certificate system receives, over a first network, identification information comprising at least identity-linked information over a first network. In some embodiments, the identity-linked information may include a phone number in plain-text, a phone number in hashed form, a device-linked identifier, a credit card number, or the like. In some embodiments, the identification information may comprise additional information useful for identifying the user or preparing data, such as a session ID, a name or other identifying information, or the like. In some exemplary embodiments, the user certificate system may receive information. In block 402 over a first network that is separate, in whole or in part, with respect to a second network, so as to enhance security. For example, in some embodiments, a user device may request services from a service provider and receive a link configured to transmit identification information to a user certificate system. Block 402 may be performed in response to user interaction with a link provided to a user device over a first network, such as a carrier network, that is separate from a second network, such as the Internet, that the user device utilized to make the original request from the service provider.

Having received the identity-linked information, the user certificate system, in block 404, queries for information linked with the identity-linked information. In some embodiments, the user certificate system may query a user certificate repository for public certificate information linked with the identity-linked identifier information, the hardware security module for information linked with the identity-linked identifier information, another system for information linked with the identity-linked identifier information, or a combination thereof. In some embodiments, such as when a user signs up for a new account with a service provider or when the user adds enhanced authentication to an existing account with a service provider, the user certificate system may not have previously linked information with the identity-linked information, and thus may then, in block 406, receive result data indicative that the user certificate system does not contain information linked to the identity-linked information.

Accordingly, in some embodiments, at block 408 the user certificate system may then cause certificate information to be linked to the identity-linked information.

In some embodiments, the certificate information comprises at least a public key and a private key. Additionally or alternatively, the certificate information may comprise public certificate information, including a public key, and/or private certificate information, including a private key. In some embodiments, the private key and public key should be configured such that messages encrypted using one of the keys may be decrypted using the other key. In some embodiments, a user certificate system may be configured to generate certificate information linked to the identity-linked information at block 408. Alternatively or additionally, a user certificate system may be configured to request certificate information linked to the identity-linked information from a certificate authority, and receive such certificate information as a response from the certificate authority. In some embodiments, the user certificate system may be configured to receive certificate validation information. For example, if a user certificate system requests certificate information from a certificate authority, the certificate authority may include in a response the certificate information and certificate validation information that may be used to verify the certificate information up to a trusted certificate authority. In some embodiments, a trusted certificate authority may be an intermediate certificate authority. In some embodiments, a trusted certificate authority may be a root certificate authority, such that there is certificate authority above the root certificate authority in a certificate validation information certificate chain.

Furthermore, in some embodiments the user certificate system may receive an ID-VERIFIED certificate from a trusted certificate authority, such as a government certificate authority. In such embodiments, the government certificate authority may be controlled by a government entity. These certificate authorities may be highly trusted by implementing a highly reliable certificate authority verification process. A high reliable certificate authority verification process may involve several highly reliable identity verification steps, such as in person appearances and/or providing government documentation. For example, a government postal service may issue ID-VERIFIED certificates after a process involving in-person appearances in which a user presents identification documents for verification. In such embodiments, the ID-VERIFIED certificate information may include additional information, such as the types of identification used in the verification process. The user certificate system may store a portion or all of this information as public certificate information as described herein.

At block 410, the user certificate system may be configured to store public certificate information from the generated certificate information in a user certificate repository. In some embodiments, a user certificate system may store public certificate information in a certificate format, such as a X.509 certificate. In some embodiments, the user certificate system stores the public certificate information in the user certificate repository associated with the identity-linked information such that the public certificate information may be retrieved from the user certificate repository using the identity-linked information.

At block 412, the user certificate system may be configured to store the private key in a hardware security module. In some embodiments, the private key may be stored associated with the identity-linked information such that the private key may be retrieved from the hardware security module using the identity-linked information. In some embodiments, the hardware security module may store private keys in an encrypted format. In some embodiments, the user certificate system may use a portion of the identification information, such as a received history or secret key, to encrypt the private key before storing it.

At block 414. the user certificate system may cause transmission, to a service provider, of a notification indicative that a portion of the linked certificate information is accessible using a session ID. In some embodiments, the user certificate system may cause a user device to transmit a notification to the service provider by transmitting a response message to a user device upon completion of storing the certificate information. In some embodiments, the user certificate system may cause the user device to transmit a notification to the service provider by transmitting a response to the user device upon receipt of the identification information at block 402.

In some embodiments, the user certificate system may cause the notification sent to the service provider to include a session ID. In some embodiments, the session ID may have been generated by the user certificate system in an earlier action, such as blocks 404-412 as depicted in FIG. 4. Alternatively or additionally, in some embodiments the session ID may be received or generated by another system, such as the user device, and transmitted to the user certificate system, such as part of the identification information received at block 402.

At block 416, the user certificate system may receive, from a service provider, a request for a portion of certificate information. In some embodiments, a user device may have requested to register a user account with the service provider, or enhance authorization with an already existing account associated with the service provider. In some embodiments, the user certificate system may receive the request for certificate information from the service provider in response to the service provider receiving the notification transmitted to the service provider in block 414. In some embodiments, the request from the service provider may comprise at least a session ID to be used in receiving the certificate information.

At block 418, the user certificate system transmits, to the service provider, the certificate information comprising at least the public key, which may then be stored by the service provider. In some embodiments, the user certificate system may utilize a session ID, such as a session ID received at block 418, to determine a portion of certificate information should be transmitted to the service provider submitting the request. In some embodiments, the information transmitted to the service provider may be in certificate format, such as X.509 certificate format.

In some embodiments, at optional block 420, the user certificate system may generate a transaction report memorializing the transmission of the certificate information to service provider, such as the transmission at block 418. In some embodiments, the transaction report may comprise information that uniquely identifies the transmission of the portion of certificate information from the user certificate system to the service provider.

In some embodiments, at optional block 422, the user certificate system may store the transaction report generated in block 420 in a ledger. In some embodiments, the user certificate system may maintain a ledger in a list, database, or other component associated with the user certificate system. Alternatively, the user certificate system may be configured to store the transaction report in a blockchain associated with the user certificate system.

Turning now to FIG. 5, which illustrates a set of operations performed by a user device, such as a user device 304, in accordance with an exemplary embodiment of the present invention.

At block 502, the user device transmits, to a service provider over a first network, a request for services. In some embodiments, the request for services may include a request to register a new user account with the service provider, or a request to enhance authentication associated with an existing user account with the service provider.

At block 504, the user device receives, from the service provider, a response comprising at least a link configured to cause transmission of information to a user certificate system upon. accessing the link. In some embodiments, the response received at block 504 may additionally comprise a session ID generated or received by the service provider from a third-party system. In sonic embodiments, the response may be a SMS sent to a device associated with the request to the service provider made in block 502. In some embodiments, the response may be a local device message displayed on the user device.

At block 506, the user device accesses the link provided at block 504. In some embodiments, the user device may be configured to access the link in response to user engagement with the user device, a display associated with the user device, or the like Additionally or alternatively, the user device may be configured to access the link automatically, for example by using a redirect or redirects, such as HTTP redirects.

At block 508, the user device transmits, to the user certificate system, identification information via a second network. In some embodiments, transmission of the identification information may cause the user certificate system to link certificate information to identity-linked information transmitted to the user certificate system. In some embodiments, the user certificate information may comprise identity-linked information. In some embodiments, the identification information may have identity-linked information included by a third-party, such. as a carrier using a process such as header enrichment. In some embodiments, the identification information may include a session ID, such as a session ID generated by the user device in an earlier step, such as blocks 502-506 as depicted in FIG. 5, received by the user device from a third-party system before beginning the steps depicted in FIG. 5, or received from a service provider, such as part of the response from the service provider in block 504.

At block 510, the user device may receive, from the user certificate system, a response notification. In some embodiments, the response notification may be indicative that at least a portion of the information linked to the identity-linked information is accessible based on a session ID. In some embodiments, the session ID may have been transmitted to the user certificate system at block 508 as described above. Alternatively or additionally, the session ID may be generated by the user certificate system and included in the response at block 510.

At block 512, in response to receiving the notification at block 510, the user device may transmit, to the service provider, a notification indicative that at least a portion of the certificate information linked to the identity-linked information, such as public certificate information, is accessible based on a session ID. In some embodiments, the user device may include the session ID in the notification to the service provider so the service provider may later provide it to the user certificate system to access the certificate information.

At block 514, the user device may cause the service provider to retrieve at least a portion of the public certificate information from the user certificate system. In some embodiments, block 514 may occur simultaneously with block 512, such that transmission of the notification to the service provider causes the service provider to retrieve the portion of the public certificate information.

Turning now to FIG. 6, which illustrates a set of operations performed by a service provider, such as a service provider 306, in accordance with an exemplary embodiment of the present invention.

At block 602, the service provider receives, over a first network, a request for services. In some embodiments, the request for services may comprise a request to create a new user account with the service provider or enhance security to a previously existing user account with the service provider. In some embodiments, the request for services may be associated with a user account, such as a new user account to be registered with the service provider or a previously existing user account.

At block 604, the service provider may configure a link such that accessing the link will cause transmission. of identification information to the user certificate system. In some embodiments, the link may be configured such that it may be included in a response to a user device.

In some embodiments, the service provider may be configured to generate a session ID. Alternatively or additionally, in some embodiments, the service provider may be configured to receive a session ID from a third-party system. In such embodiments, the service provider may be configured to generate or receive the session ID during, before, or after any of the steps illustrated by blocks 602 and 604.

At block 606, the service provider may transmit a response comprising the link to a user device. In some embodiments, the response may further comprise additional information, such as the session ID generated or received by the service provider. In some embodiments, the service provider may transmit the response at block 606 to a second user device, such that the second user device is separate from, but associated, with the user device that sent the request for services at block 602. For example, in an exemplary embodiment, the service provider may be configured to receive the request for services from a first user device, such as a laptop computer, determine a second device associated with the first user device or the user account, for example a mobile device, and transmit the response at block 606 to the second user device.

At block 608, the service provider may receive, from a user device, information indicative that a portion of public certificate information is accessible on the user certificate system based on a session ID. In some embodiments, the information received at block 608 may be notification information sent from a user device to the service provider after the user device transmitted identification information to the user certificate system over a second network, such as in block 512 depicted in FIG. 5.

At block 610, the service provider may transmit to the user certificate system, a request for at least a portion of the public certificate information. In some embodiments, the request transmitted at block 610 may comprise additional information, such as a session ID.

At block 612, the service provider may receive, from the user certificate system, a response comprising at least certificate information, such a portion of public certificate information. In some embodiments, the response information may comprise at least a public key. In some embodiments, the certificate information included in the response may be formatted in X.509 format.

At block 614, the service provider may store the response certificate information associated with a user account. In some embodiments, the service provider may store the response certificate information associated with information identifying a user account, such that the certificate information may be retrieved using the user account identifying information. In such embodiments, the service provider may retrieve the stored certificate information, or a portion of the stored certificate information, associated with a user account for use in validating an identity message in subsequent identity authorization processes, such as those described in FIGS. 7, 8, 9, and 10.

### Transmitting identity Messages to Verify Users Registered with the User Certificate System

FIG. 7 illustrates a data flow diagram depicting data flow operations for facilitating a user identification process, the identification process comprising receiving, on a user certificate system 702, identification information comprising identity-linked information, retrieving certificate information linked with the identity-linked information, configuring an identity message comprising an encoded portion that may be used to verify the identity message, and transmitting the identity message to a service provider 706 for verification.

At 710, user device 704 requests services from service provider 706 in some embodiments, the request may include, for example, a request to access a service offered by the service provider 706. In some embodiments, the request may provide a user account registered with the service provider 706 associated with the request for services. In some embodiments, the request may comprise additional information, such as a session ID. At 712, in response to receiving to receiving the request for services 710, services provider 706 may configure a link to access user certificate system 702, and transmit the link to user device 704 In some embodiments, the link may be provided to user device 704 through SMS. In some embodiments, the link may be provided to user device 704 through a local device message. In some embodiments, user device 704 may comprise a first user device and a second device, wherein the first user device may transmit the request for services over a first network 710, and the service provider 706 may transmit the link at step 712 to the second user device. In some embodiments, the second user device may be a mobile phone associated with the first user device or user account making the request for services.

At 714, user device 704 may access the link configured and transmitted in 712, which may cause transmission of identification information to the user certificate system 302. In some embodiments, the user device 704 may access the link in response to user engagement with the link. In some embodiments, the user device 704 may access the link via a redirect or redirects, such as HTTP redirects. In some embodiments, in response to accessing the link at 714, the user device 714 may transmit identification information, comprising identity-linked information, to user certificate system 702. Alternatively or additionally, a third-party, such as, for example, a mobile carrier (not shown) may include information in the transmission to user certificate system 702, such as including identity-linked information in the transmission through header enrichment.

After receiving the identification information comprising at least the identity-linked information, at 716, the user certificate system 702 may retrieve certificate information, such as public certificate information comprising a public key, from a user certificate repository. In some embodiments, the user certificate system may query user certificate repository for public certificate information corresponding to the identity-linked information, and receive result data including the certificate information. In some embodiments, the certificate information retrieved may include public certificate information. In some embodiments, the certificate information may include user information, such as a name, birthday, and the like. Alternatively or additionally, in some embodiments, the certificate information retrieved may include a public key. In some embodiments, the certificate information retrieved may be in the form of a X.509 certificate.

At 718, the user certificate system 702 may retrieve a private key from a hardware security module. In some embodiments, the user certificate system may query the hardware security module for a private key corresponding to the identity-linked information, and receive result data including the private key. Alternatively or additionally, in some embodiments, the: identification information received after step 714 may include a history or secret key, which may be used to identify and/or access the private key. For example, in some embodiments, a key included in the identification information may be used to decrypt the private key retrieved from querying the hardware security module.

At 720, the user certificate system 702 may notify user device 704 that information has been prepared on user certificate system 702 for use in generating an identity message. In some embodiments, user certificate system 702 may provide a response to a request transmitted to the user certificate system 702 in step 714. In some embodiments, the user certificate system 702 may transmit, to user device 704, information comprising a session ID.

At 722, the user device 704 may further notify service provider 706 that user certificate system 706 is prepared to transmit an identity message that is accessible based on a session ID. In some embodiments, for example, the user device 704 may receive information a response from the user certificate system 702 and transmit, to service provider 706, notification information indicative that user certificate system 706 is prepared to transmit an identity message accessible based on a session ID. In some embodiments, the user device 704 may provide additional information to the service provider 706. For example, in some embodiments, the user device 704 may transmit a session ID to the service provider 706. In such embodiments, for example, user device 704 may have generated the session ID before, during, or after a previous step. Additionally or alternatively, the user device 704 may have received the session ID from a third-party system before, during, or after a previous step. Alternatively or additionally, the user certificate system 702 may transmit the generated or received session ID to the user device, such as in step 720.

At 724, in response to receiving the notification information/request sent at 722, the service provider 706 may transmit, to user certificate system 702, a request for an identity message. In some embodiments, the request for the identity message may include a session ID generated by the service provider 706 or forwarded during a prior step, such as in the request for services at step 710 or the notification information received by the service provider 706 at step 722.

In response to receiving the request at step 724, the user certificate system 702 may, at 726, generate an identity message. Simultaneously or subsequently, at 728, the user certificate system 702 may encrypt, a portion of the identity message. In some embodiments, the user certificate system may encrypt a portion of the identity message using the private key retrieved at step 718. Additionally or alternatively, the identity message may include, in either an encrypted or unencrypted portion, the identity-linked information, a time-stamp, the session ID, and/or further identifying or securing information. In such embodiments, including additional information in the identity message improves security by minimizing the risk of message intercept and subsequent reuse.

At 730, user certificate system 702 may transmit, to service provider 706, information including at least the identity message. In some embodiments, the information may further include a portion of the public certificate information retrieved from the user certificate repository at 716. For example, in some embodiments, the information may include at least a public key that may be used to decrypt an encrypted portion of the identity message. Alternatively or additionally, additional information transmitted in step 730 may be in the form of a digital certificate, such as a X.509 certificate.

At 732, service provider 706 may validate the received identity message. In some embodiments, the identity message may be validated by decrypting an encoded portion of the identity message using a corresponding public key. In some embodiments, the public key may be stored associated with a user account. Alternatively or additionally, in some embodiments, service provider 706 may receive the public key, such as at step 730, for subsequent use.

In some embodiments, at 734, the user certificate system may be further configured to generate a transaction report. In such embodiments, the transaction report may uniquely memorialize the transmission of the identity message to service provider 706. At 736, in some embodiments, the user certificate system 702 may be configured to store the transaction report generated in 734 in a ledger. In some embodiments, the ledger may be a blockchain associated with the user certificate system 702 such that the user certificate system 702 may append new transaction reports to the blockchain.

FIGS. 8, 9, and 10 illustrate an exemplary set of operations performed in accordance with an embodiment of the present invention. Specifically, each of the FIGS. 8, 9, and 10 illustrates an exemplary set of operations performed by one of the systems user device 704, user certificate system 702, or service provider 706, such as an embodiment system functioning as shown in FIG. 1 and described in FIG. 7.

Turning, now to FIG. 8, which illustrates a set of operations performed by a user certificate system, such as a user certificate system 702, in accordance with an exemplary embodiment of the present invention. At block 802, a user certificate system may receive, over a first network, identification information comprising at least identity-linked information. In some embodiments, the identity-linked information may include a phone number in plain-text, a phone number in hashed form, a device-linked identifier, a credit card number, or the like. In some embodiments, the identification information may comprise additional information useful for identifying the user or preparing data, such as a session ID, a name, or other user information/user identifying information, or the like.

In some exemplary embodiments, the user certificate system may receive information in block 802 over a first network that is out-of-band with respect to a second network between a user device and a service provider, which may enhance security. For example, in some embodiments, a user device may request, over a first network, services from a service provider and receive a link configured to transmit identification information from a user device to a user certificate system over a second network. Block 802 may occur in response to user interaction with the link on a user device, such as a mobile phone, configured to cause transmission of the identification information over a second network, such as a carrier network, that may be separate from a first network, such as the Internet, utilized to transmit a request from a user device to the service provider.

Having received the identity-linked information, the user certificate system, at block 804, may retrieve, from a user certificate repository, public certificate information linked to the identity-linked information. In some embodiments, the public certificate information may include at least a public key. Additionally or alternatively, the public certificate information may include additional information, such as identification information. In some embodiments, the user certificate system may retrieve the public certificate information from the user certificate repository by querying the user certificate repository for information linked with the identity-linked information and receiving result data.

At block 806, the user certificate system may retrieve, from a hardware security module, a private key. In an example embodiment, the private key may be stored in the hardware security module linked to the identity-linked information, such that the hardware security module may be queried, using the identity-linked information, for the corresponding private key.

In some embodiments, the user certificate system may use additional information, such as information received at block 802, to retrieve information from the user certificate repository and/or hardware security module. For example, in some embodiments, the identification information received may include a history key, such that the history key may be a secure key stored only on the user device after a previous authentication. In such embodiments, the user certificate system may decrypt the history key before use. Alternatively or additionally, the user certificate system may utilize the history key to identify and access public certificate information retrieved from the user certificate repository. A history key may be used when a first network, such as for transmitting information between a user device and a service provider, and a second network, such as for transmitting information to a user certificate system from a user device or carrier, are the same or shared, such as a single Wi-Fi network or similar means. In such embodiments, incorporating the history key as described may increase security of the system or method.

In some embodiments, the identification information received at step 802 may additionally include a secret key that may be used to decrypt the private key retrieved from the hardware security module. In such embodiments, the user device or service provider may store the secret key, and transmit it along with other information such that the user certificate system may receive it, for example as part of the identification information in block 802.

At 808, the user certificate system may cause transmission, to the service provider, of a notification indicative that an identity message is accessible based on a session ID. In some embodiments, the user certificate system may transmit information, such as response information, to a user device to cause the user device to transmit, from the user device to a service provider, the notification indicative that an identity message is accessible based on a session ID. In some embodiments, the user certificate system may be configured to generate the session ID or receive the session ID from a third-party system before, during, or after any of the blocks 802-806. In such embodiments, the user certificate system may transmit, to the user device, information including the session ID and cause the user device to forward, to the service provider, the information including the session ID.

At 810, the user certificate system may receive, from the service provider, a request for the identity message. In an example embodiment, the request may include the session ID.

At 812, in response to receiving the request for the identity message, the user certificate system may generate the identity message. In an example embodiment, simultaneously or subsequent to generating the identity message, the user certificate system may encrypt a portion of the identity message. In some embodiments, the user certificate system may encrypt a portion of the identity message using the private key retrieved at 806. Additionally or alternatively, the user certificate system may encrypt a portion of the identity message using the private key retrieved at 806 in conjunction with additional information, such as identification information received at 802. In some embodiments, the identification information received at 802 may include a secret key used to decrypt the private key before using the private key to encrypt the portion of the identity message. Alternatively or additionally, in some embodiments, the identification information received at 802 may include a private key fragment, such that the private key fragment may be combined with the private key retrieved at block 806 to form a complete private key. In such embodiments, the complete private key may then be used to encrypt a portion of the identity message.

The identity message may be empty or comprise a set of information. In some embodiments, the identity message may be empty. In some embodiments, the identity message. may include a. time-stamp, a session ID, identity-linked information, such as a telephone number in hashed or plain-text form, or the like. Including additional information in the identity message may enhance security by minimizing the risk of message intercept and subsequent reuse.

At block 814, the user certificate system transmits the identity message to the service provider. In some embodiments, the user certificate system may transmit the identity message and additional information. In some embodiments, for example, the user certificate system may transmit a portion of the public certificate information, such as a public key, to the service provider along with the identity message. In such embodiments, the service provider may use the public key to validate the identity message.

In some embodiments, at optional block 816, the user certificate system may generate a transaction report. The transaction report may memorialize the transmission of the identity message to the service provider. In some embodiments, at optional block 818, the user certificate system may store the transaction report generated in block 816 in a ledger. In some embodiments, the user certificate system may maintain a list, database, or other component associated with the user certificate system that facilitates storage of transaction reports. Alternatively, the user certificate system may be configured to store the transaction report in a blockchain associated with the user certificate system, or submit transaction reports to be stored in a blockchain.

Turning now to FIG. 9, which illustrates a set of operations performed by a user device, such as a user device 704, in accordance with an exemplary embodiment of the present invention.

At block 902, the user device transmits, to a service provider over a first network, a request for services. In some embodiments, the request for services may include a request to log in to a service offered by the service provider, access a service, such as to perform a high-value transaction, or the like. At block 904, the user device receives, from the service provider, a response comprising at least a link configured to transmit a request to the user certificate system upon accessing the link. In some embodiments, the response received at block 904 may additionally comprise a session ID generated by the service provider or received by the service provider from a third-party. In some embodiments, the response may be a SMS sent to a user device associated with the request for services made to the service provider in block 902. In some embodiments, the response may be a local device message, such as an operating system message or application message, displayed on a user device.

At block 906, the user device accesses the link provided at block 904. In some embodiments, the user device may be configured to access the link in response to user engagement with the link on the user device, a display associated with the user device, or the like. Additionally or alternatively, the user device may be configured to access the link automatically, for example by using a redirect or redirects, such as HTTP redirects.

At block 908, the user device transmits identification information to the user certificate system over a second network. In some embodiments, transmission of the identification information may cause the user certificate system to link certificate information to identity-linked information transmitted to the user certificate system. In some embodiments, the identification information may comprise identity-linked information. In some embodiments, the identification information may have identity-linked information included during the transmission by a third-party, such as a carrier using a process such as header enrichment. In some embodiments, the identification information may include a session ID, such as a session ID generated by the user device in an earlier step, such as blocks 902-906 as depicted in FIG. 9, received by the user device from a third-party system before beginning the steps depicted in FIG. 9, or received as part of the response from the service provider in block 904.

At block 910, the user device may receive, from the user certificate system, a response notification. In some embodiments, the response notification may be indicative that at least an identity message is accessible based on a session ID. In some embodiments, the session ID may have been transmitted to the user certificate system at block 908 as described above, alternatively or additionally, the session ID may be generated by the user certificate system and included in the response at block 910.

At block 912, in response to receiving the notification at block 910, the user device may transmit, to the service provider, a notification indicative that at least an identity message is accessible based on a session ID. In some embodiments, the user device may include the session ID as information transmitted as part the notification to the service provider, such that the service provider may later transmit the session ID to the user certificate system.

At block 914, the user device may cause the service provider to retrieve the identity message from the user certificate system. In some embodiments, block 914 may occur simultaneously with block 912, such that the transmission of the notification to the service provider causes the service provider to retrieve the identity message.

Turning now to FIG. 10, which illustrates a set of operations performed by a service provider, such as a service provider 706, in accordance with an exemplary embodiment of the present invention.

At block 1002, the service provider receives, over a first network, a request for services. In some embodiments, the request for services may comprise a request to log in to a service offered by the service provider, access a service, such as to perform a high-value transaction, or the like. In some embodiments, the request for services may be associated with a user account, such as a user account previously registered with the service provider.

At block 1004, the service provider may configure a link such that accessing the link on a user device may cause transmission of identification information from a user device to the user certificate system. In some embodiments, the link may be further configured such that accessing the link may cause a third-party to include information in a transmission of the user certificate system. For example, the link may be configured such that accessing the link on a user device causes a mobile carrier to include identity-linked information, such as a phone number, in the identification information transmitted to the user certificate system.

In some embodiments, the service provider may be configured to generate a session ID. Additionally or alternatively, in some embodiments, the service provider may be configured to receive a session ID from a third-party system. In such embodiments, the service provider may be configured to generate or receive the session ID during, before, or after any of the steps illustrated by blocks 1002 or 1004.

At block 1006, the service provider may transmit, to a user device, a response including the configured link. In some embodiments, the response may further include additional information, such as the session ID generated or received by the service provider. In some embodiments, the service provider may transmit the response at block 1006 to a second user device, such that the second user device is separate but associated with the user device that sent the request for services at block 1002. For example, in an exemplary embodiment, the service provider may be configured to receive the request for services from a first user device, determine a second device, for example a mobile device, associated with the first user device or the user account, and transmit the response at block 1006 to the second user device.

At block 1008, the service provider may receive, from a user device, information indicative that a portion of public certificate information is accessible on the user certificate system based on a session ID. In some embodiments, the information received at block 1008 may be notification information sent from the user device to the service provider after the user device transmitted identification information to the user certificate system via a second network, such as in block 912 in FIG. 9.

At block 1010, the service provider may transmit to the user certificate system, an identity message request. In some embodiments, the request transmitted at block 1010 may comprise additional information, such as a session ID.

At block 1012, the service provider may receive, from the user certificate system, response information including the identity message. In some embodiments, the response information may also include additional information, such as public certificate information, such as a public key, for use in validating the identity message.

At block 1014, the service provider may validate the identity message. In an example embodiment, the identity message may include an encrypted portion. In some embodiments, the service provider may retrieve a stored public key associated with the user account that may be used to decrypt the encrypted portion of the identity message. A service provider may have stored a public key associated with a user account, such as through a registration process as described herein, for example the registration process illustrated in FIG. 3. Alternatively or additionally, the service provider may utilize the public certificate information received at block. 1012, such as a public certificate including a public key, to decrypt the identity message. By successfully decrypting the identity message, the service provider may have consider the identity message validated. Accordingly, the service profile may be certain that the user that submitted the request for services is who they claim to be based on the certainty of identity-linked information as a proxy for user identity.

In some embodiments, while a single user certificate may be used to provide identity authentication to multiple service providers, a user certificate system may be configured to support multiple certificates for a given user. In some embodiments, a user certificate system may be configured to store a single certificate for each service provider. In such embodiments, the user certificate system may receive service provider identification information for use in storing the certificate information, such as during a registration process depicted by FIG. 3, or for use in retrieving the certificate information, such as a public and private key, during an identification process, such as during the identification process depicted by FIG. 7.

In one example embodiment, a dedicated credit card certificate may be registered and linked with identity-linked information such as a user's mobile phone number, credit card account number, or the like, using the registration process depicted in FIG. 3 and further illustrated in FIGS. 4, 5, and 6. Accordingly, the credit card certificate be utilized to perform. identity authentication, using the identity authentication process depicted in FIG. 7 and further illustrated in FIGS. 8, 9, and 10, when a user requests services such as an online payment transaction with a given credit card. An exemplary system may verify a user identity, using an identity message, to a credit card issuer or other capable entity, and initiate payment.

As will be appreciated by one of ordinary skill in the art, information request and transmission steps illustrated by steps in the data flow diagrams depicted by FIGS. 3 and 7, and block(s) in flowcharts depicted by FIGS. 4, 5, 6, 8, 9, and 10, may be typically be performed in an exemplary embodiment, over HTTPs connections between devices on a network. However, as will be appreciated, such steps or block(s) may be performed over HTTP. If HTTP is used to transmit the identity-linked identifier information to a user certificate system, the transmission should be secured using alternative means, such as a private VPN or other secured means, so as to prevent vulnerability to a cyber-attack. In an exemplary embodiment, all information requests and information transmissions would occur over secure means.

As will be appreciated by one of ordinary skill in the art, the certificate-based identity message identification authentication process illustrated in FIGS. 7, 8, 9, and 10 may be used as a second-factor authentication method. Alternatively, the certificate-based identity message identification authentication process may be used in lieu of credentials. In such embodiments, possession of the user device should be confirmed using a device possession confirmation event prior to identity authentication through an identity message.

### Alternative System Architecture

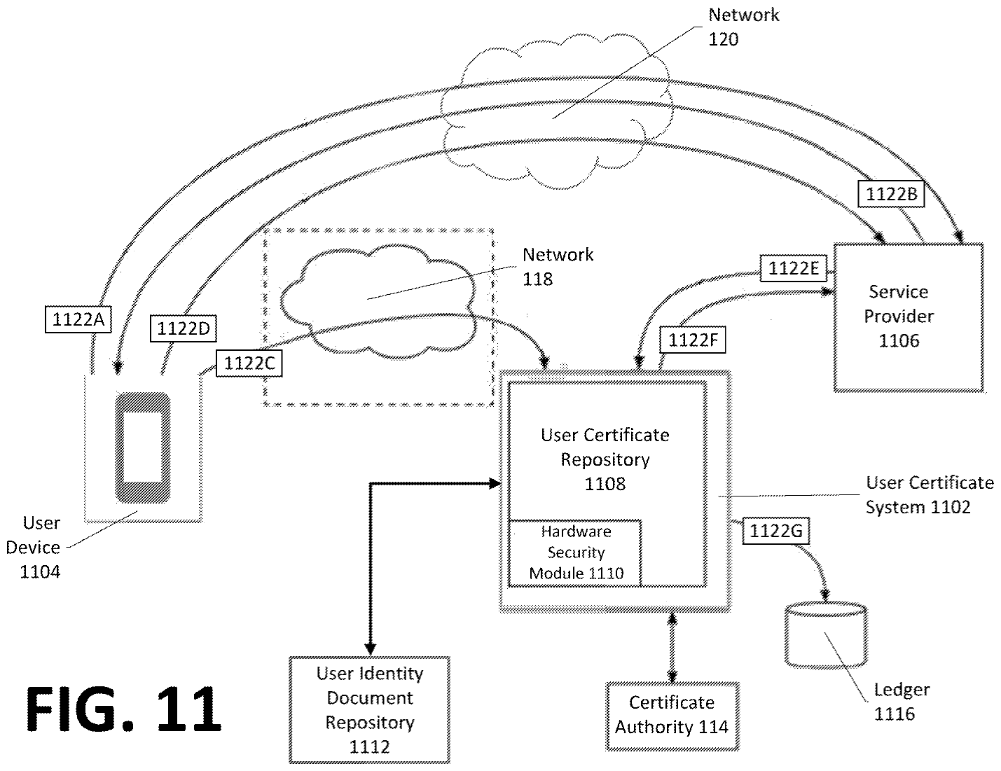

FIG. 11 illustrates an alternative system in accordance with another embodiment of the present invention. The system illustrated in FIG. 11 includes a user device 1104, a user certificate system 1102, and a service provider 1106. Additionally, user certificate system 1102 is associated with a user identity document repository 1112.

User identity document repository 1112 may be configured to store, manage, and/or release documents to a third-party, such as service provider 1106, For example, in some embodiments, the user certificate system 1102 may be configured to retrieve an identity document from user identity document repository 1112 and release it for identity purposes to service provider 1106. In some embodiments, user identity document repository 1112 may be a sub-module of user certificate system 1102. In some embodiments, user identity document repository 1112 may be system, hardware component, or device configured to communicate with user certificate system 1102. In some embodiments, the user certificate system 1102 may be configured to access the user identity document repository 1112 to store, manage, and release documents.

In some embodiments, access to a user identity document repository 1112 that is distinct from the user certificate system 1102 may occur after authentication with an identity message. In such an embodiment, the user identity document repository 1112 may be considered a second service provider that may provide services to a user to access their documents in the user identity document repository for addition, deletion, and distribution of the documents to third-parties.

FIGS. 4, 5, 6, 8, 9, and 10 illustrate example flowchart of the example operations performed by a method, apparatus, and computer program product in accordance with an embodiment of the present invention. It will be understood that each block of the flowcharts, and combinations of blocks in the flowcharts, may be implemented by various means, such as hardware, firmware, processor, circuitry, and/or other devices associated with execution of software including one or more computer program instructions.

For example, in reference to FIGS. 4, 5, 6, 8, 9, and 10, one or more of the procedures described herein may be embodied by computer program instructions. In this regard, the computer program instructions which embody the procedures described above may be stored by a memory 204 of an apparatus employing an embodiment of the present invention and executed by a processor 202 in the apparatus.

As will be appreciated by one of ordinary skill in the art, any such computer program instructions may be loaded onto a computer or other programmable apparatus (e.g., hardware) to produce a machine, such that the resulting computer or other programmable apparatus provides for implementation of the functions specified in the block(s) of the corresponding flowchart. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the block(s) of the flowchart. The computer program instructions may also be loaded onto a computer or other programmable apparatus to cause a series of operations to be performed on computer or other programmable apparatus to produce a computer-implemented process such that the instructions which execute on the computer or other programmable apparatus provide operations for implementing the functions specified in the block(s) of the flowchart. As such, the operations of FIGS. 4, 5, 6, 8, 9, and 10, when executed, convert a computer or processing circuitry into a particular machine configured to perform an example embodiment of the present invention. Accordingly, the operations of FIGS. 4, 5, 6, 8, 9, and 10 define an algorithm for configuring a computer or processing circuitry to perform an example embodiment.

Accordingly, blocks of the flowchart support combinations of means for performing the specified functions and combinations of operations for performing the specified functions. It will also be understood that one or more blocks of the flowchart, and combination of blocks in the flowchart, can be implemented by special-purpose hardware-based computer systems which perform. the specified functions, or combinations of special purpose hardware and computer instructions.

In some embodiments, certain ones of the operations herein may be modified or further amplified as described below. Moreover, in some embodiments, additional optional operations may also be included. It should be appreciated that each of the modifications, optional additions, or amplifications below may be included with the operations above either alone or in combination with any others among the features described herein.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1-27. (canceled)

28. A method of providing user identity authentication information to a service provider, the method comprising:
receiving, over a first network, identification information comprising at least identity-linked information;
retrieving, from a user certificate repository, public certificate information associated with the identity-linked information;
retrieving, from a hardware security module, a private key associated with the identity-linked information;
causing transmission, over a second network to the service provider, of an information preparation notification indicative that an identity message is ready to be accessed based on a session ID, wherein the identity message is based on the retrieved public certificate information and the retrieved private key;
receiving, from the service provider, a request for the identity message, the request for identification comprising at least the session ID;
generating the identity message, wherein the identity message comprises at least an encrypted portion of the identity message encrypted using at least the private key; and
transmitting the identity message to the service provider.

29. The method of claim 28, wherein the first network is an out-of-band from the communications network.

30. The method of claim 28, wherein the first network is a carrier network.

31. The method of claim 28, the identification information is received over the first network using header enrichment.

32. The method of claim 28, wherein the identification information further comprises the session ID.

33. The method of claim 28 further comprising:
generating the session ID in response to receiving the identification information; and
wherein causing transmission of the notification to the service provider comprises at least transmitting response information to a user device, the response information comprising at least the generated session ID.

34. The method of claim 28, wherein transmitting the identity message causes the service provider to decrypt the encrypted portion of the identity message using a public key paired with the private key.

35. The method of claim 28, wherein a portion of the identity message comprises at least one from the set of (1) an empty message, (2) a phone number, (3) a transaction time-stamp, and (4) additional identification information.

36. The method of claim 28, wherein the identification information additionally comprises information indicative of a device possession confirmation event.

37. The method of claim 28, wherein the identification information additionally comprises a history key, and the method further comprising:
receiving the history key;
validating the history key by decrypting it; and
using the history key to retrieve the public certificate information from the user certificate repository.

38. The method of claim 28, wherein the identification information is received in response to accessing a link sent via SMS to a first user device, the first user device receiving the link via SMS in response to a request for services sent to the service provider by a second user device associated with the first user device.

39. The method of claim 28, wherein the identification information is received in response to a local device message on a first user device, the first user device receiving the local device message in response to a request for services sent to a service provider by a second user device associated with the first user device.

40. The method of claim 28, wherein receiving the identification information occurs in response to a redirect on a user device.

41. The method of claim 28, wherein retrieving the public certificate information further comprises determining the public certificate information is associated with service provider identification information.

42. The method of claim 28 further comprising, after transmitting the identity message:
determining a set of identity verification documents associated with the identity-linked information, wherein the set of identity verification documents is stored in a user a user identity document repository;
selecting a document in the set of identity verification documents; and
performing a document action on the selected document.

43. The method of claim 28, wherein the identity-linked information is one from the set of (1) a one-time password, (2) a one-time password over SMS, (3) a passcode from a first user device running a time-based one-time-password algorithm, (4) a passcode from a second user device running a time-based one-time-password algorithm, (5) a passcode from a first user device running a HMAC-based one-time-password algorithm, (6) a passcode from a second user device running a HMAC-based one-time-password algorithm, (7) a FIDO key from a first user device, (8) a FIDO key from a second user device, (9) an identifier associated with a device-connected service provider device and service provider attestation information, (10) a biometric indicator, or (11) a phone number associated with a user device.

44. The method of claim 28, wherein the public certificate information comprises at least one from the group of (1) a name, (2) a social security number, (3) an identification number, and (4) a unique attribute of the user.

45. The method of claim 28 further comprising:
causing a device possession confirmation event on a user device.

46. The method of claim 28, wherein a portion of the identity-linked information comprises at least one from the group of (1) a phone number in plain-text, (2) a phone number in hashed form, and (3) a credit card number.

47. The method of claim 28 further comprising
generating a transaction report, wherein the transaction report comprises information that uniquely memorializes the transmission of the identity message to the service provider; and
storing the transaction report in a ledger.

48. The method of claim 29, wherein the ledger comprises a blockchain.

49. The method of claim 28, wherein the identification information further comprises a secret key.

50. The method of claim 49 further comprising, before encrypting the portion of identity message decrypting the private key using the additional secret key.

51. The method of claim 28, wherein the public certificate information at least a public key, and wherein the identity message comprises the encrypted portion and an unencrypted portion, and wherein the unencrypted portion of the identity message comprises at least the public certificate information.

52. The method of claim 51, wherein the public certificate information further comprises certificate validation information such that the certificate validation information can be used to verify the public certificate information was issued from a trusted certificate authority.

53. (canceled)

54. An apparatus configured to provide user identity authentication information to a service provider, the apparatus comprising at least a processor and a memory associated with the processor having computer coded instructions therein, with the computer coded instructions configured to, when executed by the processor, cause the apparatus to:
receive, over a first network, identification information comprising at least identity-linked information;
retrieve, from a user certificate repository, public certificate information associated with the identity-linked information;
retrieve, from a hardware security module, a private key associated with the identity-linked information;
cause transmission, over a second network to the service provider, of an information preparation notification indicative that an identity message is ready to be accessed based on a session ID, wherein the identity message is based on the retrieved public certificate information and the retrieved private key;
receive, from the service provider, a request for the identity message, the request for identification comprising at least the session ID;
generate the identity message, wherein the identity message comprises at least an encrypted portion of the identity message encrypted using at least the private key; and
transmit the identity message to the service provider.

55. (canceled)

56. A computer program product for providing user identity authentication information to a service provider, the computer program product comprising at least one non-transitory computer-readable storage medium having computer-executable program code instructions stored therein, the computer-executable program code instructions comprising program code instructions for:
receiving, over a first network, identification information comprising at least identity-linked information;
retrieving, from a user certificate repository, public certificate information associated with the identity-linked information;
retrieving, from a hardware security module, a private key associated with the identity-linked information;
causing transmission, over a second network to the service provider, of an information preparation notification indicative that an identity message is ready to be accessed based on a session ID, wherein the identity message is based on the retrieved public certificate information and the retrieved private key;
receiving, from the service provider, a request for the identity message, the request for identification comprising at least the session ID;
generating the identity message, wherein the identity message comprises at least an encrypted portion of the identity message encrypted using at least the private key; and
transmitting the identity message to the service provider.

57-71. (canceled)
